(19) United States
(12) Patent Application Publication
(10) Pub. No.: US 2020/0321689 A1
(43) Pub. Date: Oct. 8, 2020

(54) PROTECTIVE CASE FOR ELECTRONIC DEVICE

(71) Applicant: Otter Products, LLC, Fort Collins, CO (US)

(72) Inventors: KEVIN W. WITTER, Fort Collins, CO (US); ALYSON J. BECK, Fort Collins, CO (US); AARON M. GAYLORD, Fort Collins, CO (US); NATHAN NORTHRUP, III, Fort Collins, CO (US); GRADY E. BARFOOT, Denver, CO (US); JONATHAN MIKSCH, Fort Collins, CO (US); BENJAMIN R. WILMHOFF, Boulder, CO (US)

(21) Appl. No.: 16/838,377

(22) Filed: Apr. 2, 2020

Related U.S. Application Data
(60) Provisional application No. 62/829,899, filed on Apr. 5, 2019.

(51) Int. Cl. H01Q 1/24; H04B 1/3888; H04M 1/02; H04B 1/3827

(52) U.S. Cl. CPC H01Q 1/243; H04B 1/3838; H04M 1/0266; H04B 1/3888

(57) ABSTRACT

A protective case for an electronic device having a display, a first 5G antenna region on a rear surface of the electronic device and a second 5G antenna on a side surface of the electronic device is provided. The protective case includes a first opening providing access to the display of the installed electronic device. The protective case includes a first antenna region opening on a rear surface of the protective case aligned with the first 5G antenna region providing direct access to the first 5G antenna region of the installed electronic device The protective case includes a second antenna region opening on a side surface of the protective case aligned with the second 5G antenna region providing direct access to the second 5G antenna of the installed electronic device.

### CROSS REFERENCE TO RELATED APPLICATIONS

This application claims priority to U.S. Provisional Application No. 62/829,899, filed Apr. 5, 2019, the disclosure of which is hereby incorporated by reference in its entirety.

### FIELD

The present disclosure relates to cases, covers, and/or encasements for use with electronic devices.

### BACKGROUND

Portable electronic devices are commonly used for communication and entertainment purposes. Portable electronic devices include devices such as smartphones, cellular phones, mobile communication devices, computers, portable computing devices, mobile computing devices, tablet computers, cameras, video players, smart watches, audio players, electronic media readers, two-way radios, global positioning satellite (GPS) devices, measurement instruments, and/or other types of electronic, computing, or communication devices, including combinations thereof. Cases, protective cases, covers, protective covers, enclosures, or encasements are sometimes installed on or over housings of these types of electronic devices in order to protect the electronic devices from damage due to exposure to shock, impact, dropping, puncture, dust, dirt, water, snow, rain, mud, chemicals, and/or other potentially damaging forces or elements. The term “case” is used herein to refer to any type of case, cover, protective case, protective cover, enclosure, encasement, shell, or combination thereof. Cases are also sometimes used to supplement the functionality of the device and/or to change the aesthetics of the device.

Electronic devices transmit and receive data over wireless communication networks. In order to achieve higher data rates, cellular communication networks are implementing a fifth generation (“5G”) digital cellular network. The 5G networks operate according to standards set forth by the 3rd Generation Partnership Project (“3GPP”) TF 21.915 Release 15. To achieve the higher data rates, many 5G networks utilize radio waves in or near the millimeter wave band above 3 GHz, and in some more particular cases from 30 GHz to 300 GHz. The 5G bands utilize higher frequencies than earlier generations, which typically operated in the microwave band between 700 MHz and 3 GHz.

Electronic devices utilizing 5G networks to transmit and/or receive data typically have one or more internal antennas for communicating with the 5G network. Improved systems, apparatuses, and methods for protecting electronic devices with 5G antennas and other problems are desired.

### SUMMARY

In one exemplary embodiment, a protective case for an electronic device having a display, a first 5G antenna region on a rear surface of the electronic device, and a second 5G antenna on a side surface of the electronic device is provided. The protective case includes a first opening providing access to the display of the installed electronic device. The protective case includes a first antenna region opening on a rear surface of the protective case aligned with the first 5G antenna region providing direct access to the first 5G antenna region of the installed electronic device The protective case includes a second antenna region opening on a side surface of the protective case aligned with the second 5G antenna region providing direct access to the second 5G antenna of the installed electronic device.

In some embodiments, the protective case is a two-piece case comprising an inner cushion layer that surrounds a portion of the electronic device when the electronic device is installed in the protective case and a more rigid outer shell including one or more curved side walls configured to releasably engage the inner cushion layer. In an even more particular embodiment, the inner cushion layer includes a first material and the outer shell includes a second material, the first material and the second material each being substantially opaque to radio waves having a frequency from 30 GHz to 300 GHz. In another more particular embodiments, the first antenna region opening includes a first aperture through the inner cushion layer and a first aperture through the outer shell. In a still more particular embodiment, the first antenna region opening is further configured to be aligned with a camera region of the electronic device and provide direct access to the camera region when the electronic device is installed in the protective case. In another still more particular embodiment, the protective case further includes a camera region opening on the back surface of the protective case, the camera region opening being separate and distinct from the first antenna region opening, the camera region opening comprising a second aperture through the inner cushion layer and a second aperture through the outer shell. In another more particular embodiment, the first opening and the first antenna region opening are separated by a boundary comprising the inner cushion layer. In a still more particular embodiment, the boundary further includes the outer shell. In another more particular embodiment, the first opening and the first antenna region opening comprise a single aperture defined by a single perimeter. In another more particular embodiment, the case further includes a third antenna region opening on a side surface of the protective case, the third antenna region opening configured to be aligned with and provide direct access to a third 5G antenna region on a side surface of the electronic device when the electronic device is installed in the protective case. In a still more particular embodiment, the first opening, the first antenna region opening, and the second antenna region opening comprise a single aperture defined by a single perimeter.

In some embodiments, the protective case is a one-piece case comprising a cushioning member that surrounds a portion of the electronic device when the electronic device is installed in the protective case and a more rigid structural member permanently affixed to the cushioning member. In a more particular embodiment, the cushioning member includes a first material and the structural member includes a second material, the first material and the second material each being substantially opaque to radio waves having a frequency from 30 GHz to 300 GHz. In another more particular embodiment, the first antenna region opening includes a first aperture through the cushioning member and a first aperture through the structural member. In a still more particular embodiment, the first antenna region opening is further configured to be aligned with a camera region of the electronic device and provide direct access to the camera region when the electronic device is installed in the protective case. In another still more particular embodiment, the protective case further includes a camera region opening on the back surface of the protective case, the camera region opening being separate and distinct from the first antenna region opening, the camera region opening comprising a second aperture through the cushioning member and a second aperture through the structural member. In another more particular embodiment, the first opening and the first antenna region opening are separated by a boundary comprising the cushioning member. In a still more particular embodiment, the boundary further includes the structural member. In another more particular embodiment, the first opening and the first antenna region opening comprise a single aperture defined by a single perimeter. In another more particular embodiment, the case further includes a third antenna region opening on a side surface of the protective case, the third antenna region opening configured to be aligned with and provide direct access to a third 5G antenna region on a side surface of the electronic device when the electronic device is installed in the protective case. In a still more particular embodiment, the first opening, the first antenna region opening, and the second antenna region opening comprise a single aperture defined by a single perimeter. In another embodiment, at least a portion of the cushioning member and a portion of the structural member includes a transparent material.

In some embodiments, the protective case is a multi-layer case comprising a rigid shell that surrounds a portion of the electronic device when the electronic device is installed in the protective case and a cushion layer removably disposable over the rigid shell. In a more particular embodiment, the rigid shell includes a first material and the cushion layer includes a second material, the first material and the second material each being substantially opaque to radio waves having a frequency from 30 GHz to 300 GHz. In a more particular embodiment, the first antenna region opening includes a first aperture through the rigid shell and a first aperture through the cushion layer. In a still more particular embodiment, the first antenna region opening is further configured to be aligned with a camera region of the electronic device and provide direct access to the camera region when the electronic device is installed in the protective case. In another still more particular embodiment, the protective case further includes a camera region opening on the rear surface of the protective case, the camera region opening being separate and distinct from the first antenna region opening, the camera region opening comprising a second aperture through the rigid shell and a second aperture through the cushion layer. In another more particular embodiment, the case further includes an inner foam liner affixed to the rigid shell and configured to contact at least a portion of a rear surface of the electronic device when the electronic device is installed in the protective case. In a still more particular embodiment, the first antenna region opening includes a first aperture through the rigid shell, a first aperture through the cushion layer, and a first aperture through the inner foam liner. In another more particular embodiment, the first opening and the first antenna region opening are separated by a boundary comprising the rigid shell. In a still more particular embodiment, the boundary further includes the cushion layer. In another more particular embodiment, the first opening and the first antenna region opening comprise a single aperture defined by a single perimeter. In another more particular embodiment, the case further includes a third antenna region opening on a side surface of the protective case, the third antenna region opening configured to be aligned with and provide direct access to a third 5G antenna region on a side surface of the electronic device when the electronic device is installed in the protective case. In still another more particular embodiment, the first opening, the first antenna region opening, and the second antenna region opening comprise a single aperture defined by a single perimeter.

In some embodiments, the protective case includes a holster. In a more particular embodiment, the holster includes a back, at least two receivers positioned along a first edge of the back and configured to releasably engage a side of protective case, and a flexible arm positioned along a second edge of the back opposite the first edge, the flexible arm including a latch configured to engage a receiver on the protective case to secure the protective case to the holster. In a still more particular embodiment, the holster includes a first open area positioned between the two receivers, the first open area configured to provide direct access to the second antenna region on the side surface of the electronic device through the second antenna region opening of the protective case when the electronic device is installed in the protective case and the protective case is secured in the holster. In another still more particular embodiment, the holster includes a second open area positioned between the flexible arm and a corner of the holster, the second open area configured to provide direct access to the second antenna region on the side surface of the electronic device through the second antenna region opening of the protective case when the electronic device is installed in the protective case and the protective case is secured in the holster. In another still more particular embodiment, the holster includes a third open area positioned on the back of the holster, the third open area configured to provide direct access to the first antenna region of the electronic device on the rear surface of the electronic device through the first antenna region opening of the protective case when the electronic device is installed in the protective case and the protective case is secured in the holster. In an even still more particular embodiment, the third open area is an aperture formed in the back of the holster.

In one exemplary embodiment, a holster for an electronic device is provided. The electronic device has a first 5G antenna region on a rear surface of the electronic device and a second 5G antenna region on a side surface of the electronic device. The holster includes a back including a first open area configured to provide direct access to the first antenna region of the electronic device when the electronic device is secured to the holster. The holster also includes at least two receivers positioned along a first edge of the back and configured to releasably engage a side of electronic device. The holster also includes a flexible arm positioned along a second edge of the back opposite the first edge, the flexible arm including a latch configured to engage a receiver on the electronic device to secure the electronic device to the holster. In a more particular embodiment, the holster also includes a second open area positioned between the two receivers, the second open area configured to provide direct access to the second antenna region on the side surface of the electronic device when the electronic device is secured in the holster. In another more particular embodiment, the holster also includes a third open area positioned between the flexible arm and a corner of the holster, the third open area configured to provide direct access to the second antenna region on the side surface of the electronic device when the electronic device is secured in the holster. In another more particular embodiment, the first open area is an aperture formed in the back of the holster. In another more particular embodiment, the holster also includes a second open area positioned between the two receivers and a third open area positioned between the flexible arm and a corner of the holster, wherein the second open area is configured to provide direct access to the second antenna region on the side surface of the electronic device when the electronic device is secured in the holster in a first configuration, and wherein the third open area configured to provide direct access to the second antenna region on the side surface of the electronic device when the electronic device is secured in the holster in a second configuration. In a still more particular embodiment, the third open area is configured to provide direct access to a third antenna region positioned on a second side surface of the electronic device when the electronic device is secured in the holster in the first configuration and the second open area is configured to provide direct access to the third antenna region when the electronic device is secured in the holster in the second configuration.

Various other embodiments and variations of the disclosed techniques and methods are possible. While multiple embodiments are disclosed, still other embodiments will become apparent to those skilled in the art from the following detailed description and figures, which describe and show illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

The present invention will be described and explained through the use of the accompanying drawings in which:

FIG. 1 illustrates a front view of an exemplary electronic device.

FIG. 2 illustrates a rear view of the electronic device of FIG. 1.

FIG. 3 illustrates a left side view of the electronic device of FIG. 1.

FIG. 4 illustrates a right side view of the electronic device of FIG. 1.

FIG. 5 illustrates a front view of the electronic device of FIG. 1 installed in a first exemplary embodiment of a protective case.

FIG. 6 illustrates a rear view of the electronic device and protective case of FIG. 5.

FIG. 7 illustrates a left side view of the electronic device and protective case of FIG. 5.

FIG. 8 illustrates a right side view of the electronic device and protective case of FIG. 5.

FIG. 9 illustrates a front view of the electronic device of FIG. 1 installed in a second exemplary embodiment of a protective case.

FIG. 10 illustrates a rear view of the electronic device and protective case of FIG. 9.

FIG. 11 illustrates a left side view of the electronic device and protective case of FIG. 9.

FIG. 12 illustrates a right side view of the electronic device and protective case of FIG. 9.

FIG. 13 illustrates an enlarged view of a portion of the right side view of FIG. 12.

FIG. 14 illustrates a front view of the electronic device of FIG. 1 installed in a third exemplary embodiment of a protective case.

FIG. 15 illustrates a rear view of the electronic device and protective case of FIG. 14.

FIG. 16 illustrates a left side view of the electronic device and protective case of FIG. 14.

FIG. 17 illustrates a right side view of the electronic device and protective case of FIG. 14.

FIG. 18 illustrates an enlarged view of a portion of the right side view of FIG. 17.

FIG. 19 illustrates a front view of the electronic device of FIG. 1 installed in a fourth exemplary embodiment of a protective case.

FIG. 20 illustrates a front view of the protective case of FIG. 19 without the installed electronic device.

FIG. 21 illustrates a front view of an alternative embodiment of the protective case of FIG. 19 without the installed electronic device.

FIG. 22 illustrates a rear view of the electronic device and protective case of FIG. 19.

FIG. 23 illustrates a left side view of the electronic device and protective case of FIG. 19.

FIG. 24 illustrates a right side view of the electronic device and protective case of FIG. 19.

FIG. 25 illustrates a front view of the electronic device of FIG. 1 installed in a fifth exemplary embodiment of a protective case.

FIG. 26 illustrates a rear view of the electronic device and protective case of FIG. 25.

FIG. 27 illustrates a left side view of the electronic device and protective case of FIG. 25.

FIG. 28 illustrates a right side view of the electronic device and protective case of FIG. 25.

FIG. 29 illustrates the electronic device and protective case of FIG. 21 inserted in a first exemplary embodiment of a holster.

FIG. 30 illustrates a rear view of the holster of FIG. 29 with the electronic device and protective case inserted.

FIG. 31 illustrates a left side view of the holster of FIG. 29 with the electronic device and protective case inserted.

FIG. 32 illustrates a right side view of the holster of FIG. 29 with the electronic device and protective case inserted.

FIG. 33 illustrates the electronic device and protective case of FIG. 21 inserted in a second exemplary embodiment of a holster.

FIG. 34 illustrates a rear view of the holster of FIG. 33 with the electronic device and protective case inserted.

FIG. 35 illustrates a left side view of the holster of FIG. 33 with the electronic device and protective case inserted.

FIG. 36 illustrates a right side view of the holster of FIG. 33 with the electronic device and protective case inserted.

FIG. 37 illustrates the electronic device and protective case of FIG. 21 inserted in a third exemplary embodiment of a holster.

FIG. 38 illustrates a rear view of the holster of FIG. 37 with the electronic device and protective case inserted.

FIG. 39 illustrates a left side view of the holster of FIG. 37 with the electronic device and protective case inserted.

FIG. 40 illustrates a right side view of the holster of FIG. 37 with the electronic device and protective case inserted.

### DETAILED DESCRIPTION

In the following detailed description, various specific details are set forth in order to provide an understanding of and describe the apparatuses and techniques introduced here. However, the techniques may be practiced without the specific details set forth in these examples. Various alternatives, modifications, and/or equivalents will be apparent to those skilled in the art without varying from the spirit of the introduced apparatuses and techniques. For example, while the embodiments described herein refer to particular features, the scope of this solution also includes embodiments having different combinations of features and embodiments that do not include all of the described features. Accordingly, the scope of the techniques and solutions introduced herein are intended to embrace all such alternatives, modifications, and variations as fall within the scope of the claims, together with all equivalents thereof. Therefore, the description should not be taken as limiting the scope of the invention, which is defined by the claims.

Some of the cases described herein are described as protective cases. However, the apparatuses and techniques disclosed herein are not to be limited to any particular protective characteristic of the case and may be applicable to various types of cases, covers, and/or encasements which cover an electronic device either partially or fully and may not have any particular protective characteristic.

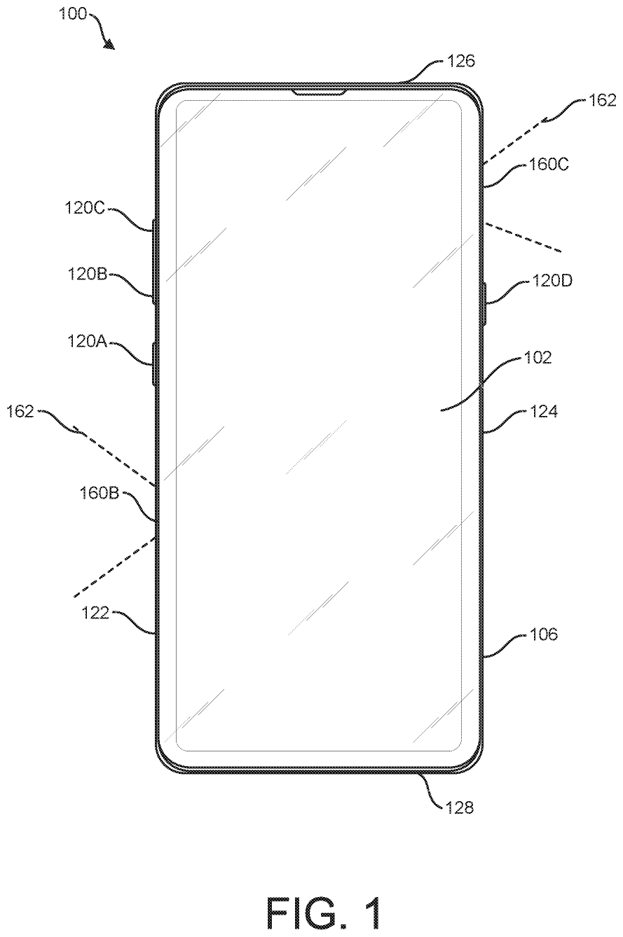

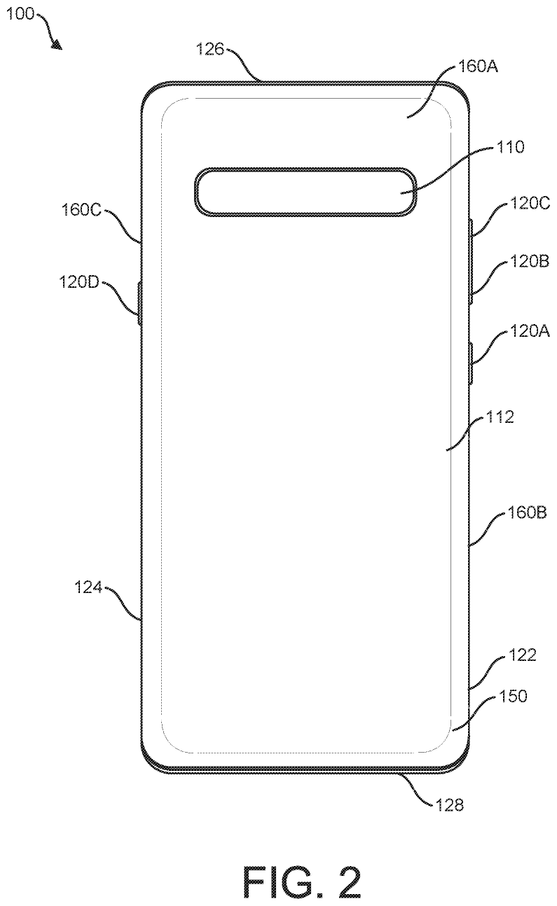

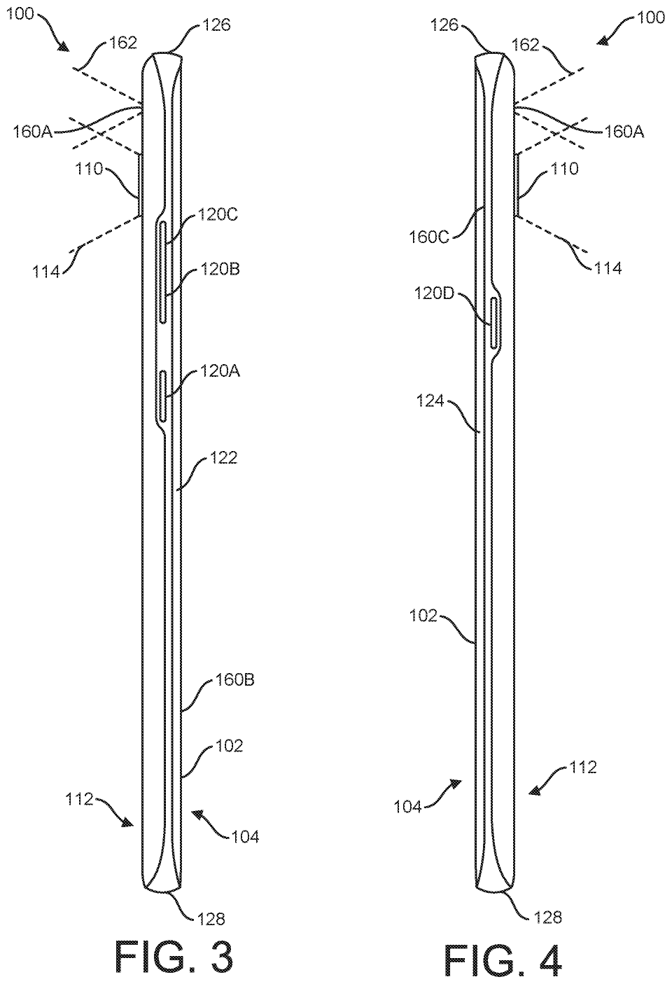

FIGS. 1-4 illustrate an exemplary electronic device 100. Electronic device 100 may be a cellular phone, smartphone, mobile communication device, mobile computing device, portable computing device, tablet, phablet (phone/tablet), portable computer, personal video player, electronic media reader, audio player, handheld scanner, camera, GPS device, or electronic computing or communication device of another type, including combinations thereof. In one specific example, electronic device 100 may be an APPLE IPHONE. In another specific example, electronic device 100 may be a SAMSUNG GALAXY phone. In still another specific example, electronic device 100 may be a GOOGLE PIXEL phone. FIG. 1 illustrates a front view of electronic device 100. FIG. 2 illustrates a rear view of electronic device 100. FIG. 3 illustrates a left side of electronic device 100. FIG. 4 illustrates a right side of electronic device 100.

Electronic device 100 includes an electronic display 102, such as a touch screen display, for displaying information to a user of electronic device 100. As illustrated in FIG. 1, in some embodiments, electronic display 102 is positioned on a front surface 104 of electronic device 100. In some embodiments, electronic display 102 is at least partially surrounded by a bezel 106 defining at least a portion of a perimeter of front surface 104.

Electronic device 100 includes one or more cameras positioned in a camera region 110. In some embodiments, camera region 110 is positioned on a rear surface 112 of electronic device 100. In some embodiments, one or more additional cameras are positioned on a front surface 104 of electronic device 100. As illustrated in FIGS. 3 and 4, in some embodiments, camera region 110 may extend beyond the remainder of the rear surface 112 of electronic device 100. In some embodiments, camera region 110 is associated with one or more keep-out zones 114, which define a field of vision of the camera or cameras in the camera region into which any protective case should not intrude.

Electronic device 100 includes one or more input buttons 120. In some embodiments, one or more input buttons 120A, 120B, 120C are positioned on a left side 122 and/or one or more input buttons 120D position on right side 124 of electronic device 100. In some embodiments, one or more input buttons 120 are positioned on a front surface 104 and/or rear surface 112 of electronic device 100.

Electronic device 100 further includes a top surface 126 and a bottom surface 128. Electronic device 100 may include one or more features (not shown) selected from the group consisting of a microphone, a speaker, an electronic port, a charging port, a headphone port, a proximity sensor, and a fingerprint sensor positioned on front surface 102, rear surface 112, left surface 122, right surface 124, top surface 126 and/or bottom surface 128.

Electronic device 100 includes a housing 150 at least partially covering an outer surface of electronic device 100. In some embodiments, housing 150 covers at least a portion of rear surface 112, left surface 122, and right surface 124.

Electronic device 100 includes one or more antenna regions 160 each corresponding to an antenna positioned under housing 150 of electronic device. In some exemplary embodiments, one or more of the antennas are 5G antennas. Although 5G protocols are exemplified in many of the presented embodiments and claims, the improvements discussed herein are not to be specifically limited to systems designated 5G or containing 5G antennas, and may pertain to any type of radio frequency (RF) communication or device in the frequency range. In the illustrated embodiment, electronic device 100 includes a rear antenna region 160A positioned on rear surface 112, a left antenna region 160B positioned on left surface 122, and a right antenna region 160C positioned on a right surface 124. In some embodiments, electronic device 100 includes only one or two antenna regions 160, or electronic device 100 includes four or more antenna regions 160.

In some embodiments, antenna regions 160 corresponding to one or more 5G antennas positioned under housing 150 on front surface 104, rear surface 112, left surface 122, right surface 124, top surface 126, and/or bottom surface 128. In some embodiments, antenna regions 100 are positioned on two or more surfaces selected from front surface 104, rear surface 112, left surface 122, right surface 124, top surface 126, and bottom surface 128. Without wishing to be held to any particular theory, it is believed that positioning antenna regions 100 and corresponding antennas on two or more surfaces provides better data transfer for electronic device 100.

In some embodiments, each antenna region 160 is associated with one or more keep-out zones 162, which define a region into which any protective case should not intrude to prevent interference with the one or more antenna in the corresponding antenna region 160.

A protective case may be used to protect electronic device. Protective cases comprise any type of protective shell, cover, covering, enclosure, bumper, frame, sheath, encasement, member, and/or a combination thereof used with the electronic device 100. The protective case may provide protection against forces or damaging elements such as shock, impact, dropping, puncture, dust, dirt, heat, cold, water, snow, rain, mud, fluids chemicals, and/or other potentially damaging elements. In various instances, the protective case may be waterproof, watertight, and/or water-resistant. In other examples, techniques disclosed herein may implemented in the form of a cover for electronic device 100 which provides some or all of the functions disclosed herein while having little or no protective characteristics. The protective case may include one member or portion, two members or portions, three members or portions, or more than three members or portions that attach to each other. Some of these members may be permanently attached to each other and some of these members may be removably attachable to each other for insertion and/or removal of electronic device 100 from the protective case. In some situations, the protective case may be a one-piece case or a one-piece assembly into which electronic device 100 snaps or slides. In other situations, the protective case may contain multiple pieces that are assembled on, over, or around electronic device 100. In addition to an outer shell, the protective case may also include one or more cushion members, cushion layers, cushion liners, and/or cushion portions that are removably attached or permanently attached to any combination of the one, two, or more members. The techniques disclosed herein are not to be limited to any particular type, structure, or configuration of case.

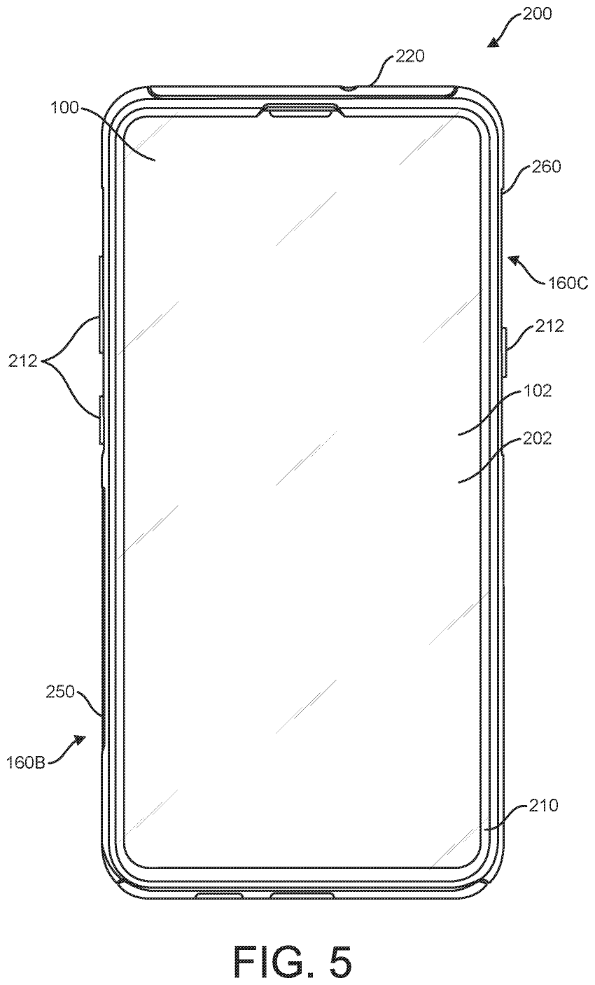

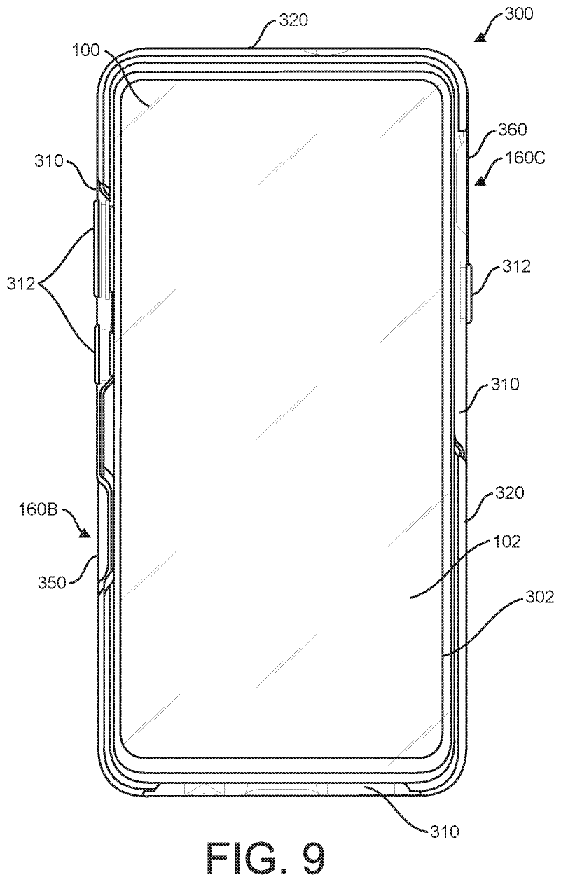

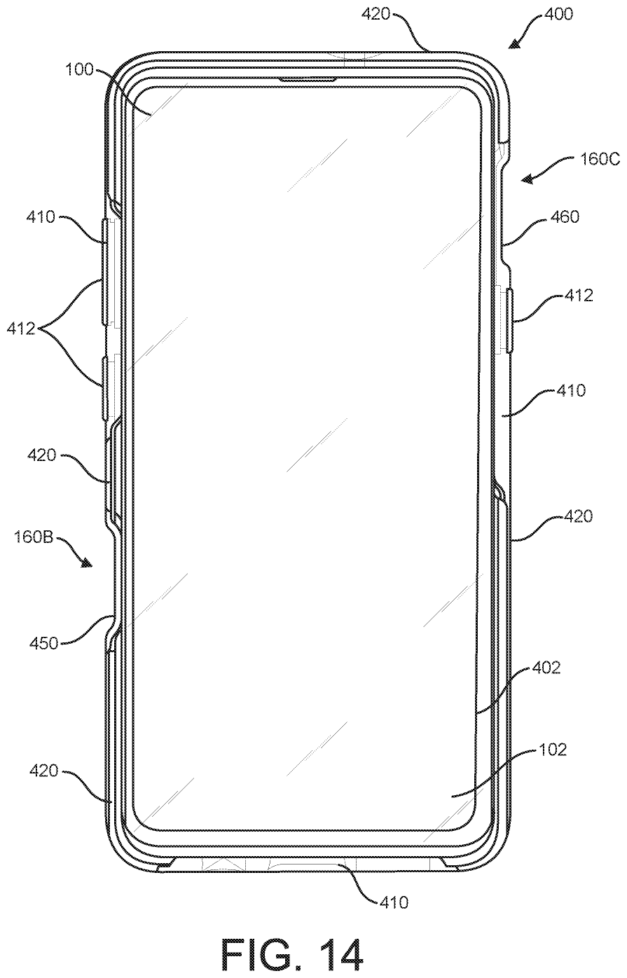

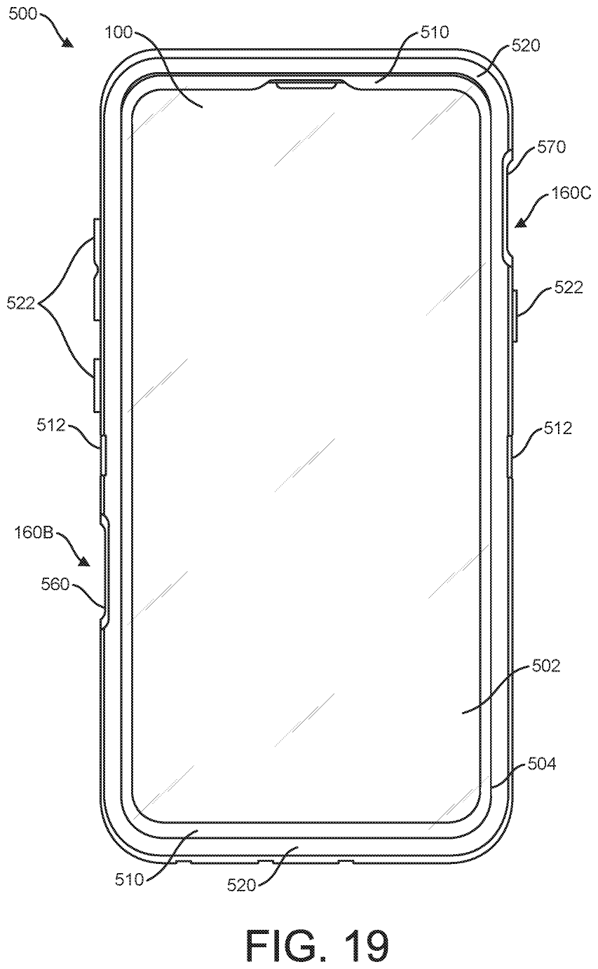

Exemplary protective cases are described herein, including protective case 200 (FIGS. 5-8), protective case 300 (FIGS. 9-13), protective case 400 (FIGS. 14-18), protective case 500 (FIGS. 19-23), protective case 600 (FIGS. 24-28).

Portions of the protective case may be made of any suitable material, including, but not limited to, polycarbonate (PC), high impact polystyrene (HIPS), nylon, fiberglass-filled nylon, acrylonitrile butadiene styrene (ABS), polyoxymethylene (POM), polyethylene terephthalate (PET), silicone, ceramic, metallized ceramic, aluminum, aluminum alloy, titanium, wood, carbon fiber, and/or any combination thereof. Without wishing to be held to any particular theory, it is believed that certain materials are substantially opaque to radio waves having wavelengths used in 5G networks. Generally, frequencies in or near the millimeter wave band above 3 GHz, and in some more particular cases from 30 GHz to 300 GHz, are blocked or substantially blocked by certain materials typically used in the construction of protective cases. Therefore, without the improvements discussed herein, the electronic device 100 may have no or limited communication with a 5G network when positioned within a suitable protective case.

Referring next to FIGS. 5-8, a first embodiment of a protective case 200 for electronic device 100 is illustrated. FIG. 5 illustrates a front view of protective case 200 with inserted electronic device 100. FIG. 2 illustrates a rear view of protective case 200 with inserted electronic device 100. FIG. 3 illustrates a left side of protective case 200 with inserted electronic device 100. FIG. 4 illustrates a right side of protective case 200 with inserted electronic device 100.

Protective case 200 is illustratively a two-piece protective case, including an inner cushion cover 210 that surrounds a portion of electronic device 100 and an outer shell 220. Exemplary two-piece protective cases are disclosed in U.S. Pat. No. 9,580,221, the disclosures of which are hereby incorporated by reference in their entirety.

In some embodiments, the outer shell 220 is formed from a more rigid material, such as polycarbonate, nylon, polycarbonate and nylon blend, a polycarbonate methyl methacrylate butadiene styrene or other similar material that can bend without breaking. Outer shell 220 includes one or more curved side walls 222 overlaying and engaging the inner cushion cover 210 to secure the inner cushion cover 210 to the electronic device 100.

In some embodiments, inner cushion cover 210 is formed from a softer and/or more stretchable material than outer shell 220 to stretch over and form a relatively tight fit over electronic device 100. Inner cushion cover 210 illustratively includes one or more raised pads 212 each providing access to one or more input buttons 120 of electronic device 100.

Protective case 200 includes a first opening 202 providing direct access to display 102 of electronic device 100. In some embodiments, inner cushion cover 210 defines the perimeter boundary of first opening 202, as illustrated in FIGS. 5-8.

Protective case 200 further includes a rear camera opening 230 providing direct access to camera region 110 of electronic device 100. By direct access to camera region 110, it is meant that camera region 110 is directly exposed to an environment and not covered or overlaid by any portion of protective case 200. A first aperture 232 in inner cushion cover 210 is aligned with a first aperture 234 in outer shell 220 to provide rear camera opening 230. In some embodiments, a rear surface of protective case 200 surrounding rear camera opening 230 is beveled or otherwise recessed to maintain one or more keep-out-zones of the one or more cameras in camera region 110 free from any obstructions.

Protective case 200 further includes a rear antenna region opening 240 providing direct access to rear antenna region 160A of electronic device 100. By direct access to antenna region 160, it is meant that the housing 150 covering antenna region 160 is directly exposed to an environment and not covered or overlaid by any portion of protective case 200. A second aperture 242 in inner cushion cover 210 is aligned with a second aperture 244 in outer shell 220 to provide rear antenna region opening 240. In some embodiments, a rear surface of protective case 200 surrounding rear antenna region opening 240 is beveled or otherwise recessed to maintain one or more keep-out-zones of the one or more antennas in rear antenna region 160A free from any obstructions.

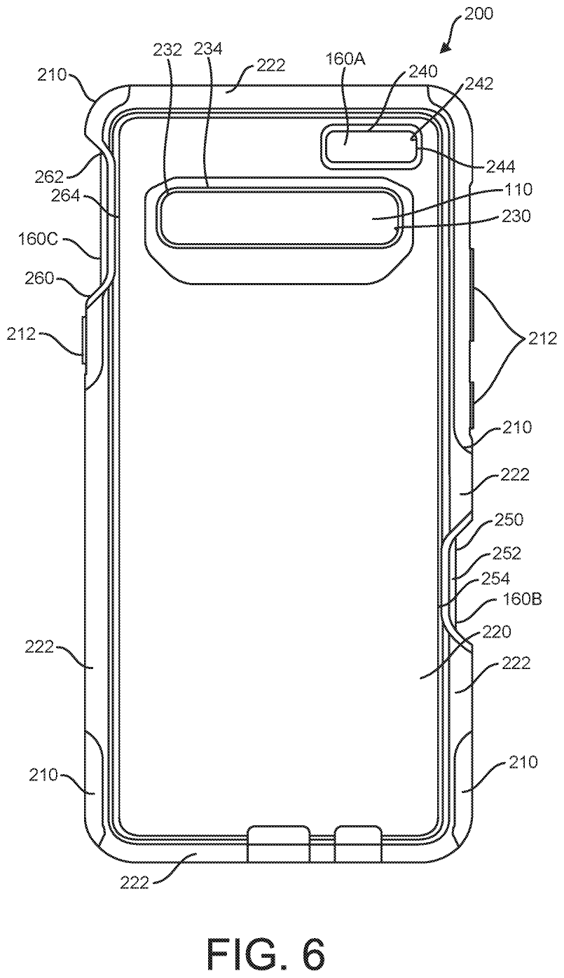

In the embodiment illustrated in FIG. 6, rear camera opening 230 and rear antenna region opening 240 are separate and distinct openings in the rear surface of protective case 200. In other embodiments, rear camera opening 230 and rear antenna region opening 240 form a single opening in the rear surface of protective case 200 and a single aperture in inner cushion cover 210 is aligned with a single aperture in outer shell 220 to provide the single opening in the rear surface of protective case 200.

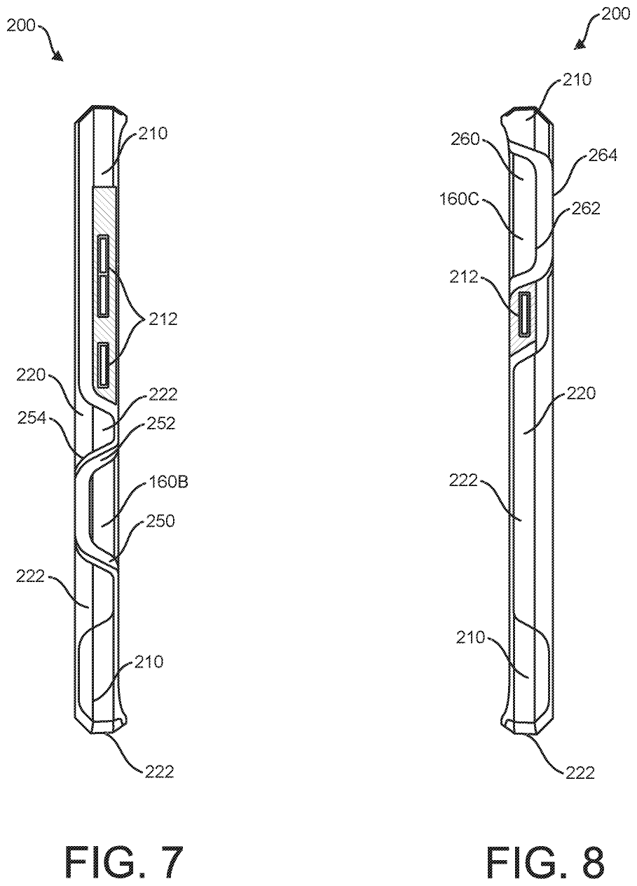

Protective case 200 further includes a left antenna region opening 250 providing direct access to left antenna region 160B of electronic device 100. In the embodiment illustrated in FIG. 7, three sides of left antenna region opening 250 are defined by a first set-back region 252 of inner cushion cover 210 and a first set-back region 254 of outer shell 220. A fourth side of left antenna region opening 250 is open to first opening 202 of protective case 200, which provides direct access to display 102 of electronic device. In other embodiments (not shown), the perimeter of left antenna region opening 250 is completely defined by an aperture in inner cushion cover 210 and an aligned opening in outer shell 220, and the left antenna region opening 250 is a separate and distinct from first opening 202 of protective case 200.

In some embodiments, left antenna region opening 250 is at least partially bounded by one or more curved side walls 222 on one or more sides of left antenna region opening 250. In some embodiments, left antenna region opening 250 is bounded by one curved side wall 222 on a first side and an outer corner of protective case 200 formed from inner cushion cover 210 on an opposing side.

Protective case 200 further includes a right antenna region opening 260 providing direct access to right antenna region 160C of electronic device 100. In the embodiment illustrated in FIG. 8, three sides of right antenna region opening 260 are defined by a second set-back region 262 of inner cushion cover 210 and a second set-back region 264 of outer shell 220. A fourth side of right antenna region opening 260 is open to first opening 202 of protective case 200, which provides direct access to display 102 of electronic device. In other embodiments (not shown), the perimeter of right antenna region opening 260 is completely defined by an aperture in inner cushion cover 210 and an aligned opening in outer shell 220, and the right antenna region opening 260 is a separate and distinct from first opening 202 of protective case 200.

In some embodiments, right antenna region opening 260 is at least partially bounded by one or more curved side walls 222 on one or more sides of right antenna region opening 260. In some embodiments, right antenna region opening 260 is bounded by one curved side wall 222 on a first side and an outer corner of protective case 200 formed from inner cushion cover 210 on an opposing side.

In some embodiments, left antenna region opening 250 is aligned with right antenna region opening 260. In other embodiments, as illustrated in FIGS. 5-8, left antenna region opening 250 is not aligned with right antenna region opening 260.

In the illustrated embodiment, protective case 200 provides direct access to electronic device 100 from left antenna region 1606 across display 102 to right antenna region 160C. That is, protective case 200 includes a single opening encompassing first opening 202, left antenna region opening 250, and right antenna region opening 260.

In some embodiments, rear antenna region opening 240, left antenna region opening 250, and/or right antenna region opening 260 is covered with a membrane or other suitable material that is substantially transparent to radio waves having wavelengths used in 5G networks. In some embodiments, a perimeter of rear antenna region opening 240, left antenna region opening 250, and/or right antenna region opening 260 includes a waterproof seal between the housing 150 of the installed electronic device 100 the perimeter of the respective opening 240, 250, 260 to prevent water from entering an interior of protective case 200.

In some embodiments, one or more sides of protective case 200 may include one or more finger ridges or hand grips to encourage a user to hold the protective case 200 in a certain way to prevent the user from covering or otherwise blocking rear antenna region opening 240, left antenna region opening 250, and/or right antenna region opening 260.

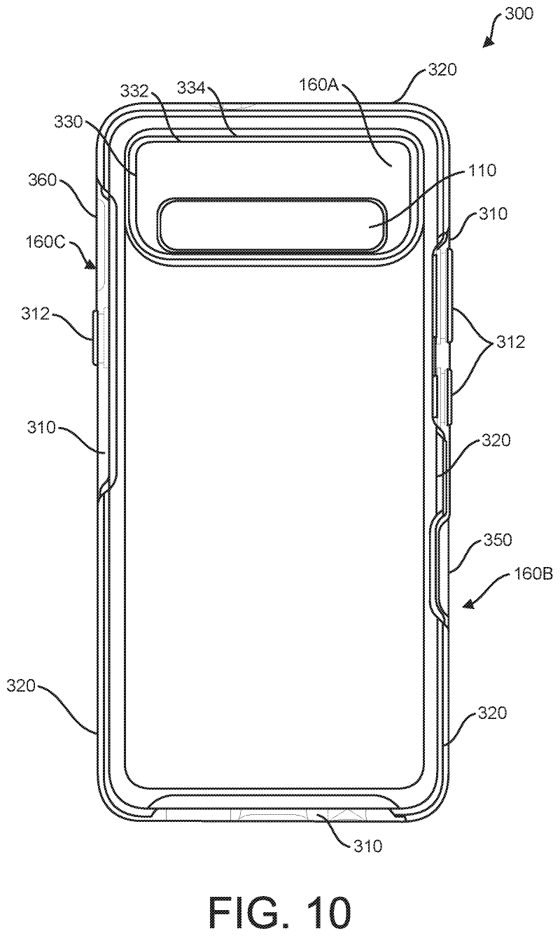

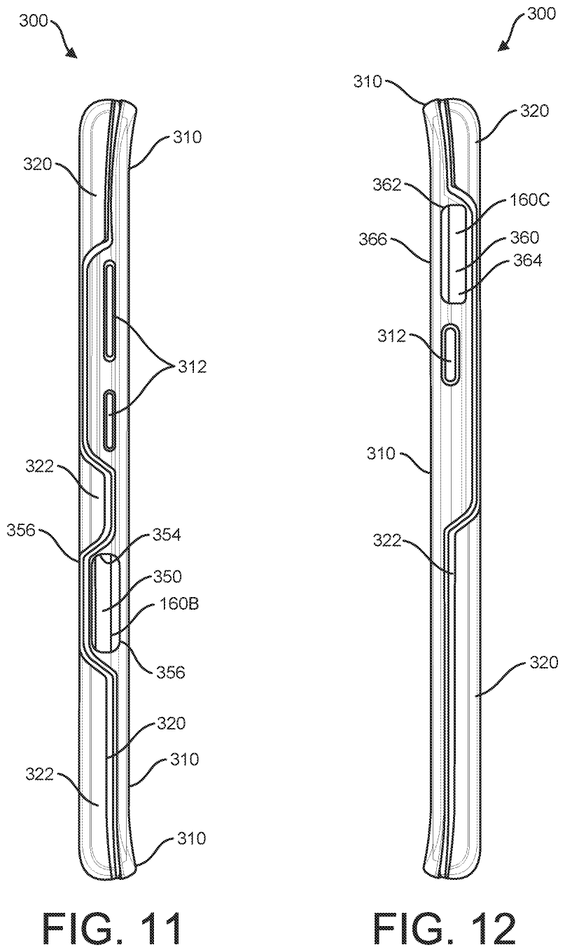

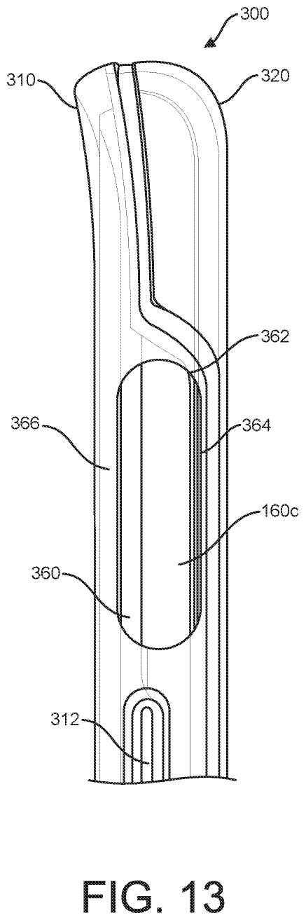

Referring next to FIGS. 9-13, a second embodiment of a protective case 300 for electronic device 100 is illustrated. FIG. 9 illustrates a front view of protective case 300 with inserted electronic device 100. FIG. 10 illustrates a rear view of protective case 300 with inserted electronic device 100. FIG. 11 illustrates a left side of protective case 300 with inserted electronic device 100. FIG. 12 illustrates a right side of protective case 300 with inserted electronic device 100. FIG. 13 illustrates an enlarged right side view of protective case 300 with inserted electronic device 100.

Protective case 300 is illustratively a one-piece protective case, including a cushioning member 310 that surrounds a portion of electronic device 100 and a structural member 320 permanently affixed to the cushioning member. Exemplary one-piece protective cases are disclosed in U.S. Pat. No. 10,136,716, the disclosures of which are hereby incorporated by reference in their entirety.

In some embodiments, the structural member 320 is formed from a more rigid material, such as polycarbonate, nylon, glass filled nylon, or other suitable material. In some embodiments, cushioning member 310 is formed from a softer material than structural member 320, such as a thermoplastic elastomer or silicone rubber. Cushioning member 310 may be overmolded within structural member 320 or otherwise permanently affixed to structural member 320 to form protective case 300. In some embodiments, cushioning member 310 and/or structural member 320 is formed from a transparent or semi-transparent material to allow a user to view electronic device 100 through protective case 300. Cushioning member 310 illustratively includes one or more raised pads 312 each providing access to one or more input buttons 120 of electronic device 100. Structural member 320 includes one or more curved side walls 322 extending over a side portion of cushioning member 310.

Protective case 300 includes a first opening 302 providing direct access to display 102 of electronic device 100. In some embodiments, cushioning layer 310 defines the perimeter boundary of first opening 302, as illustrated in FIGS. 9-13.

Protective case 300 further includes a single rear opening 330 providing direct access to camera region 110 and rear antenna region 160A of electronic device 100. A rear aperture 332 in cushioning member 310 is aligned with a rear aperture 334 in structural member 320 to provide single rear opening 330. In some embodiments, a rear surface of protective case 300 surrounding rear opening 330 is beveled or otherwise recessed to maintain one or more keep-out-zones of the one or more cameras in camera region 110 and/or antennas in rear antenna region 160A free from any obstructions.

Protective case 300 further includes a left antenna region opening 350 providing direct access to left antenna region 1606 of electronic device 100. In the embodiment illustrated in FIG. 11, three sides of left antenna region opening 350 are defined by a first region 352 of cushioning member 310 and a first region 354 of outer shell 320. A fourth side of left antenna region opening 350 is bounded by a second region 356 of cushioning member 310, but not bounded by any corresponding region of structural member 320.

In some embodiments, left antenna region opening 350 is at least partially bounded by one or more curved side walls 322 on one or more sides of left antenna region opening 350. In some embodiments, left antenna region opening 350 is bounded by one curved side wall 322 on a first side and an outer corner of protective case 300 formed from cushioning member 310 on an opposing side.

Protective case 300 further includes a right antenna region opening 360 providing direct access to left antenna region 1606 of electronic device 100. In the embodiment illustrated in FIGS. 12 and 13, three sides of right antenna region opening 360 are defined by a first region 362 of cushioning member 310 and a first region 364 of outer shell 320. A fourth side of right antenna region opening 360 is bounded by a second region 366 of cushioning member 310, but not bounded by any corresponding region of structural member 320.

In some embodiments, right antenna region opening 360 is at least partially bounded by one or more curved side walls 322 on one or more sides of right antenna region opening 360. In some embodiments, right antenna region opening 360 is bounded by one curved side wall 322 on a first side and an outer corner of protective case 300 formed from cushioning member 310 on an opposing side.

In some embodiments, left antenna region opening 250 is aligned with right antenna region opening 260. In other embodiments, as illustrated in FIGS. 5-8, left antenna region opening 250 is not aligned with right antenna region opening 260.

In the illustrated embodiment, left antenna region opening 350 is separated from first opening 302 only by a second region 356 of cushioning member 310 and right antenna region opening 360 is separated from first opening 302 only a second region 366 of cushioning member 310.

In some embodiments, single rear opening 330, left antenna region opening 350, and/or right antenna region opening 360 is covered with a membrane or other suitable material that is substantially transparent to radio waves having wavelengths used in 5G networks. In some embodiments, a perimeter of single rear opening 330, left antenna region opening 350, and/or right antenna region opening 360 includes a waterproof seal between the housing 150 of the installed electronic device 100 the perimeter of the respective opening 330, 350, 360 to prevent water from entering an interior of protective case 300.

In some embodiments, one or more sides of protective case 300 may include one or more finger ridges or hand grips to encourage a user to hold the protective case 300 in a certain way to prevent the user from covering or otherwise blocking single rear opening 330, left antenna region opening 350, and/or right antenna region opening 360.

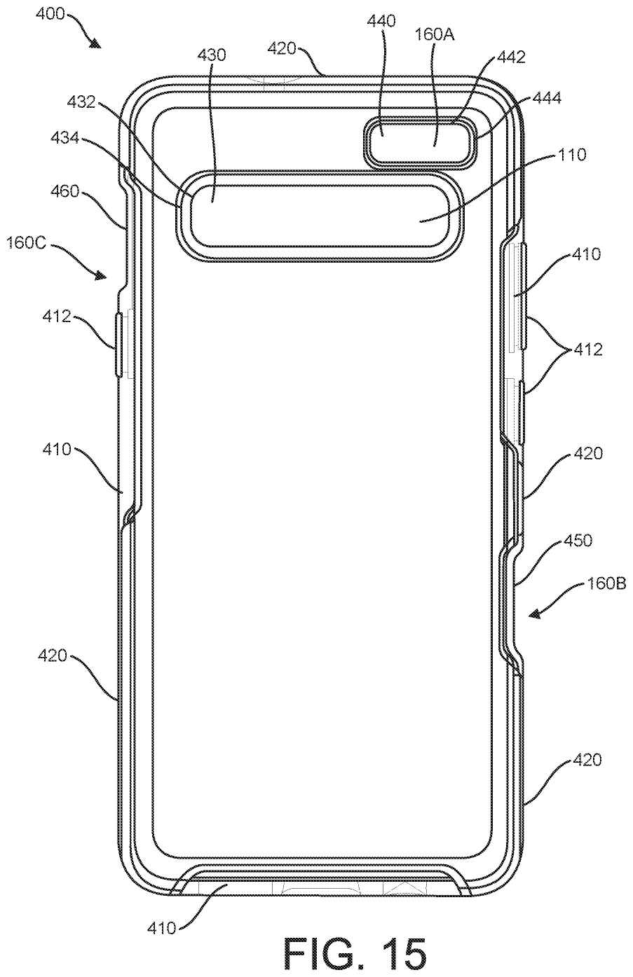

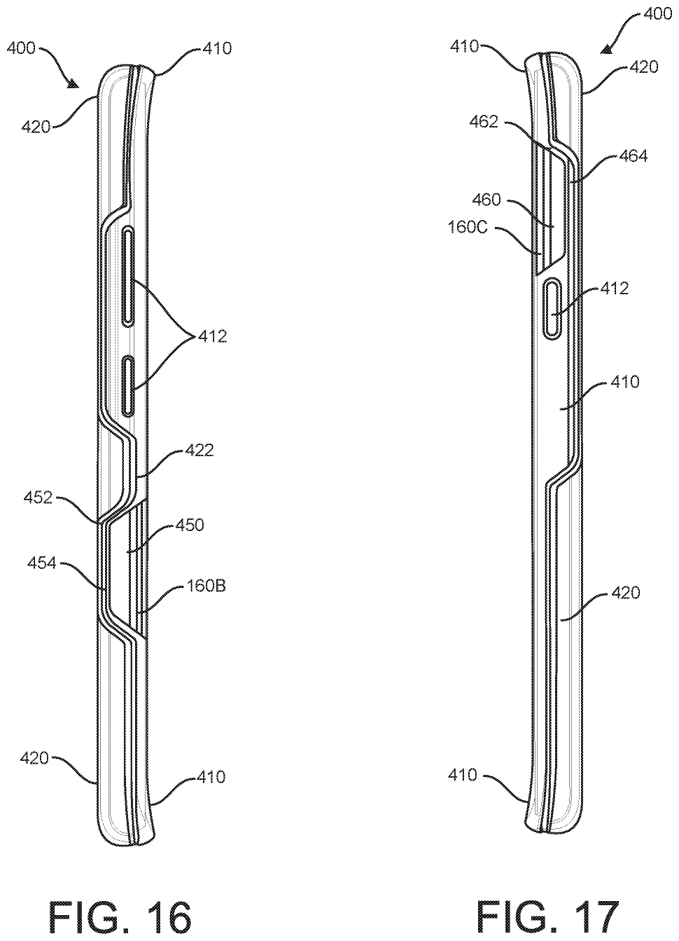

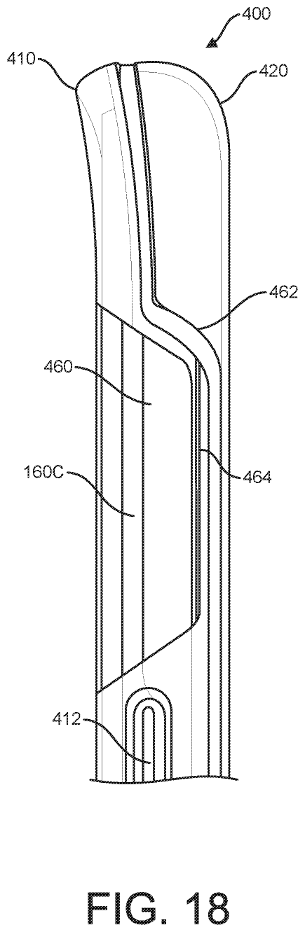

Referring next to FIGS. 14-18, a third embodiment of a protective case 400 for electronic device 100 is illustrated. FIG. 14 illustrates a front view of protective case 400 with inserted electronic device 100. FIG. 15 illustrates a rear view of protective case 500 with inserted electronic device 100. FIG. 16 illustrates a left side of protective case 400 with inserted electronic device 100. FIG. 17 illustrates a right side of protective case 400 with inserted electronic device 100. FIG. 18 illustrates an enlarged right side view of protective case 400 with inserted electronic device 100.

Protective case 400 is illustratively a one-piece protective case, including a cushioning member 410 that surrounds a portion of electronic device 100 and a structural member 420 permanently affixed to the cushioning member.

In some embodiments, the structural member 420 is formed from a more rigid material, such as polycarbonate, nylon, glass filled nylon, or other suitable material. In some embodiments, cushioning member 410 is formed from a softer material than structural member 420, such as a thermoplastic elastomer or silicone rubber. Cushioning member 410 may be overmolded within structural member 420 or otherwise permanently affixed to structural member 420 to form protective case 400. In some embodiments, cushioning member 410 and/or structural member 420 is formed from a transparent or semi-transparent material to allow a user to view electronic device 100 through protective case 400. Cushioning member 410 illustratively includes one or more raised pads 412 each providing access to one or more input buttons 120 of electronic device 100. Structural member 420 includes one or more curved side walls 422 extending over a side portion of cushioning member 410.

Protective case 400 includes a first opening 402 providing direct access to display 102 of electronic device 100. In some embodiments, cushioning layer 410 defines the perimeter boundary of first opening 402, as illustrated in FIGS. 14-18.

Protective case 400 further includes a rear camera opening 430 providing direct access to camera region 110 of electronic device 100. A first aperture 432 in cushioning member 410 is aligned with a first aperture 434 in structural member 420 to provide rear camera opening 430. In some embodiments, a rear surface of protective case 400 surrounding rear camera opening 430 is beveled or otherwise recessed to maintain one or more keep-out-zones of the one or more cameras in camera region 110 free from any obstructions.

Protective case 400 further includes a rear antenna region opening 440 providing direct access to rear antenna region 160A of electronic device 100. A second aperture 442 in cushioning member 410 is aligned with a second aperture 444 in structural member 420 to provide rear antenna region opening 440. In some embodiments, a rear surface of protective case 400 surrounding rear antenna region opening 440 is beveled or otherwise recessed to maintain one or more keep-out-zones of the one or more antennas in rear antenna region 160A free from any obstructions.

In the embodiment illustrated in FIG. 15, rear camera opening 430 and rear antenna region opening 440 are separate and distinct openings in the rear surface of protective case 400.

Protective case 400 further includes a left antenna region opening 450 providing direct access to left antenna region 1606 of electronic device 100. In the embodiment illustrated in FIG. 16, three sides of left antenna region opening 450 are defined by a first set-back region 452 of cushioning member 410 and a first set-back region 454 of structural member 420. A fourth side of left antenna region opening 450 is open to first opening 402 of protective case 200, which provides direct access to display 102 of electronic device.

In some embodiments, left antenna region opening 450 is at least partially bounded by one or more curved side walls 422 on one or more sides of left antenna region opening 450. In some embodiments, left antenna region opening 450 is bounded by one curved side wall 422 on a first side and an outer corner of protective case 400 formed from cushioning member 410 on an opposing side.

Protective case 400 further includes a right antenna region opening 460 providing direct access to right antenna region 160C of electronic device 100. In the embodiment illustrated in FIGS. 17 and 18, three sides of right antenna region opening 460 are defined by a second set-back region 462 of cushioning member 410 and a second set-back region 464 of structural member 420. A fourth side of right antenna region opening 460 is open to first opening 402 of protective case 400, which provides direct access to display 102 of electronic device.

In some embodiments, right antenna region opening 460 is at least partially bounded by one or more curved side walls 422 on one or more sides of right antenna region opening 460. In some embodiments, right antenna region opening 460 is bounded by one curved side wall 422 on a first side and an outer corner of protective case 400 formed from inner cushion cover 410 on an opposing side.

In some embodiments, left antenna region opening 450 is aligned with right antenna region opening 460. In other embodiments, as illustrated in FIGS. 14-18, left antenna region opening 450 is not aligned with right antenna region opening 460.

In the illustrated embodiment, protective case 400 provides direct access to electronic device 100 from left antenna region 1606 across display 102 to right antenna region 160C. That is, protective case 400 includes a single opening encompassing first opening 402, left antenna region opening 450, and right antenna region opening 460.

In some embodiments, rear antenna region opening 440, left antenna region opening 450, and/or right antenna region opening 460 is covered with a membrane or other suitable material that is substantially transparent to radio waves having wavelengths used in 5G networks. In some embodiments, a perimeter of rear antenna region opening 440, left antenna region opening 450, and/or right antenna region opening 460 includes a waterproof seal between the housing 150 of the installed electronic device 100 the perimeter of the respective opening 440, 450, 3460 to prevent water from entering an interior of protective case 400.

In some embodiments, one or more sides of protective case 400 may include one or more finger ridges or hand grips to encourage a user to hold the protective case 400 in a certain way to prevent the user from covering or otherwise blocking rear antenna region opening 340, left antenna region opening 450, and/or right antenna region opening 460.

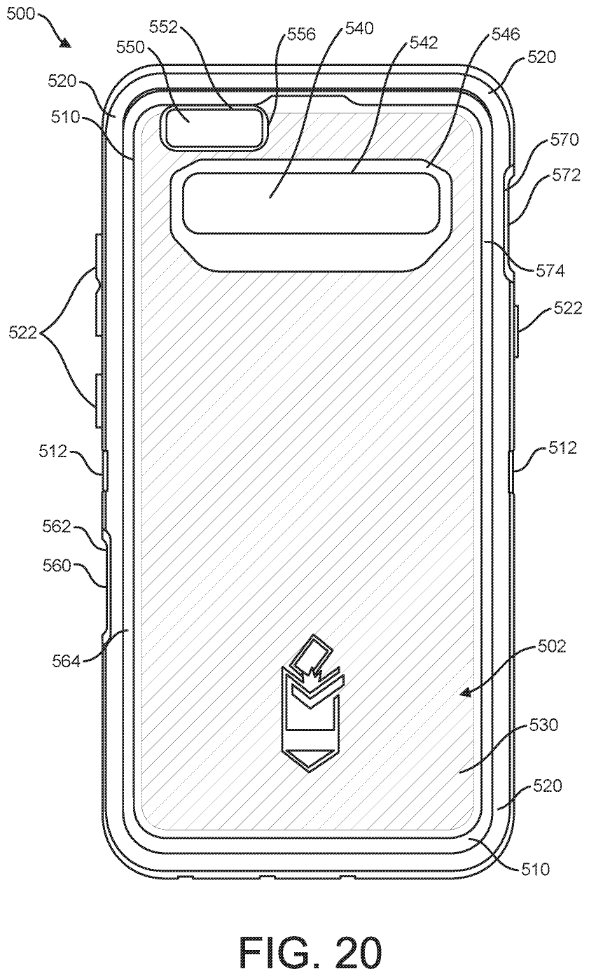

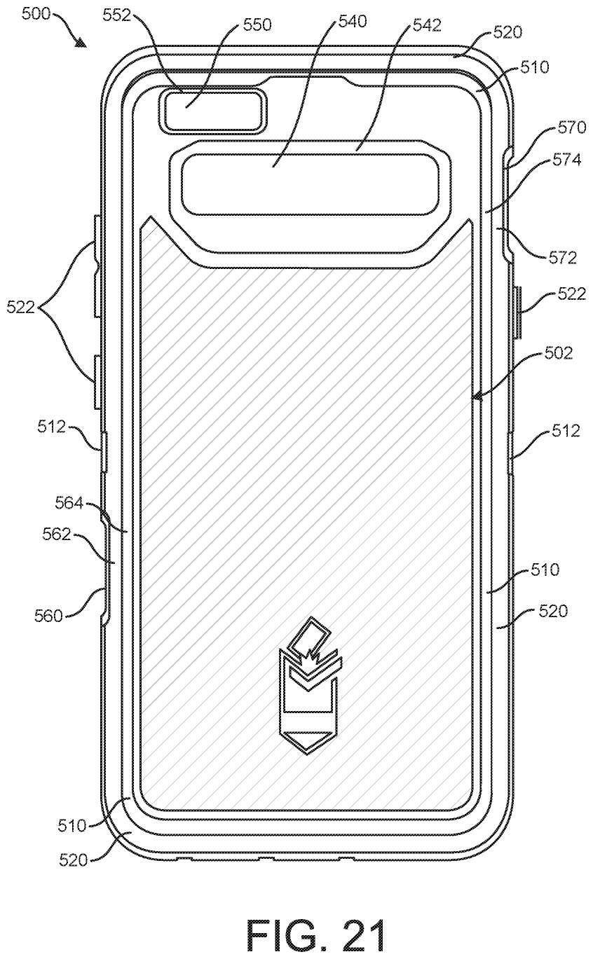

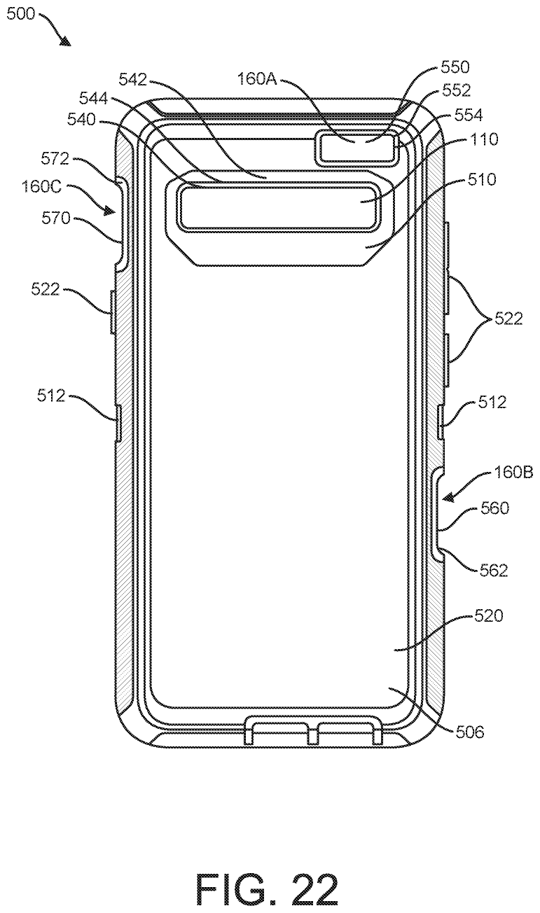

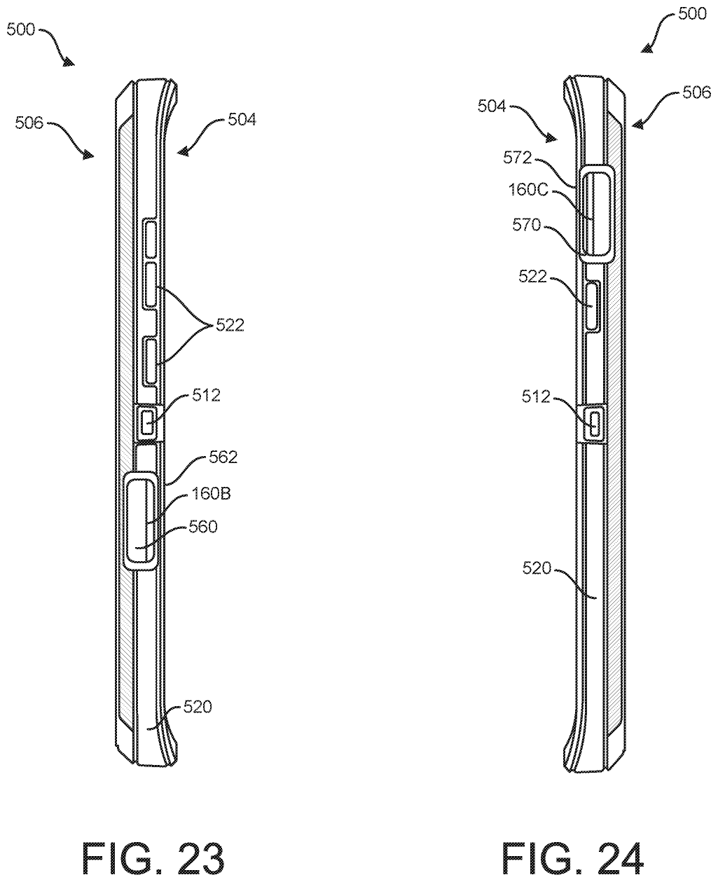

Referring next to FIGS. 19-23, a fourth embodiment of a protective case 500 for electronic device 100 is illustrated. FIG. 19 illustrates a front view of protective case 500 with inserted electronic device 100. FIG. 20 illustrates a front view of protective case 500 without inserted electronic device 100. FIG. 21 illustrates a front view of an alternative embodiment of protective case 500 without inserted electronic device 100. FIG. 22 illustrates a rear view of protective case 500 with inserted electronic device 100. FIG. 23 illustrates a left side of protective case 500 with inserted electronic device 100. FIG. 24 illustrates a right side of protective case 500 with inserted electronic device 100.

Protective case 500 is illustratively a multi-layer protective case, including a rigid shell 510 that surrounds a portion of electronic device 100 and a cushion layer 520 removably disposable over the rigid shell 510. Exemplary multi-layer protective cases are disclosed in U.S. Pat. No. 9,888,753, the disclosures of which are hereby incorporated by reference in their entirety.

Protective case 500 includes a first opening 502 providing access to display 102 of electronic device 100. In some embodiments, first opening 502 allows direct access to display 102 of electronic device 100. In other embodiments, first opening 502 includes a membrane or screen protector at least partially covering display 102, the membrane or screen protector permitting interactive touch through the membrane or screen protector to allow a user to interact with display 102 through the membrane or screen protector.

Protective case 500 includes a first side 504 including first opening 502 providing access to display 102 of installed electronic device 100 and a second side 506 configured to cover at least a portion of rear surface 112 of installed electronic device 100.

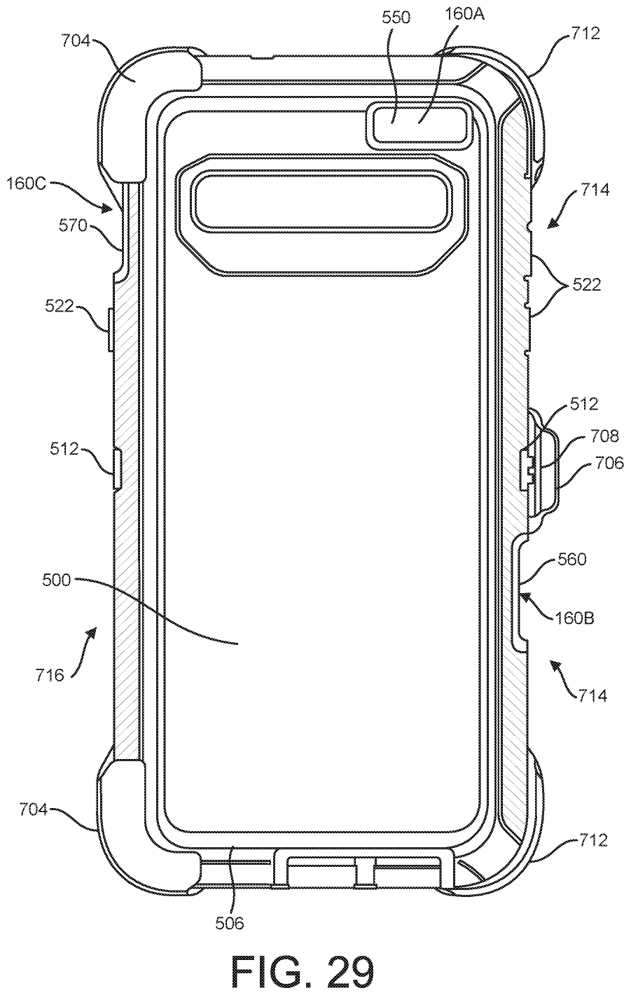

In some embodiments, the rigid shell 510 may include a first member partially covering a front surface 104 of electronic device 100 and a second member at least partially covering a rear surface 112 of electronic device 100, the first member and the second member releasably affixed to each other with one or more snaps. In some embodiments, the rigid shell 510 is formed from a rigid material, such as polycarbonate, ABS materials, propylene, thermal plastics, metals, composite materials, and other rigid materials used in injection molding. Rigid shell 510 may include one or more receivers 512 configured to releasably affix protective case 500 to a holster (see FIGS. 29-40).

In some embodiments, the cushion layer 520 fits snugly over the assembled rigid shell 510 to provide cushioning in a drop situation. In some embodiments, the cushion layer is formed from a thermoplastic material such as rubber or silicon, urethane, or other suitable material capable of stretching over the assembled rigid shell 510. In some embodiments, cushion layer 520 includes one or more raised pads 522 each providing access to one or more input buttons 120 of electronic device 100.

As illustrated in FIG. 20, in some embodiments, protective case 500 includes an inner foam liner 530. In some embodiments, inner foam liner 530 is affixed to an inner surface of rigid shell 510 to contact at least a portion of rear surface 112 of electronic device 100 when electronic device 100 is installed in protective case 500.

As illustrated in FIG. 21, in some embodiments, only a portion of the inner surface of rigid shell 510 is covered with inner foam liner 530, and an area of the inner surface next to the rear antenna region 160A of installed electronic device 100 is not covered inner foam liner 530.

Protective case 500 includes a rear camera opening 540 providing direct access to camera region 110 of electronic device 100. A first aperture 542 in rigid shell 510 is aligned with a first aperture 544 in cushion layer 520 to provide rear camera opening 540. In some embodiments, the first aperture 542 and first aperture 544 are further aligned with a first aperture 546 in inner foam liner 530 to provide rear camera opening 540 (See FIG. 20). In some embodiments, a rear surface of protective case 500 is beveled or otherwise recessed to maintain one or more keep-out-zones of the one or more cameras in camera region 110 free from any obstructions.

Protective case 500 further includes a rear antenna region opening 550 providing direct access to rear antenna region 160A of electronic device 100. A second aperture 552 in rigid shell 510 is aligned with a second aperture 554 in cushion layer 520 and a second aperture 556 in inner foam liner 530 to provide rear antenna region opening 550. In some embodiments, a rear surface of protective case 500 is beveled or otherwise recessed to maintain one or more keep-out-zones of the one or more antennas in rear antenna region 160A free from any obstructions.

In the embodiment illustrated in FIGS. 20 and 21, rear camera opening 540 and rear antenna region opening 550 are separate and distinct openings in the rear surface of protective case 500.

Protective case 500 further includes a left antenna region opening 560 providing direct access to left antenna region 1606 of electronic device 100. In the embodiment illustrated in FIG. 22, left antenna region opening 560 is defined by a perimeter 562 of rigid shell 510 and a perimeter 564 of cushion layer 520.

Protective case 500 further includes a right antenna region opening 570 providing direct access to right antenna region 160C of electronic device 100. In the embodiment illustrated in FIG. 23, right antenna region opening 570 is defined by a perimeter 572 of rigid shell 510 and a perimeter 574 of cushion layer 520.

In some embodiments, left antenna region opening 560 is aligned with right antenna region opening 570. In other embodiments, as illustrated in FIGS. 19-23, left antenna region opening 560 is not aligned with right antenna region opening 570.

In the illustrated embodiment, left antenna region opening 560 is separated from first opening 502 by perimeter 562 of rigid shell 510 and perimeter 564 of cushion layer 520 and right antenna region opening 360 is separated from first opening 502 by perimeter 572 of rigid shell 510 and perimeter 574 of cushion layer 520.

In some embodiments, rear antenna region opening 550, left antenna region opening 560, and/or right antenna region opening 570 is covered with a membrane or other suitable material that is substantially transparent to radio waves having wavelengths used in 5G networks. In some embodiments, a perimeter of rear antenna region opening 550, left antenna region opening 560, and/or right antenna region opening 570 includes a waterproof seal between the housing 150 of the installed electronic device 100 the perimeter of the respective opening 550, 560, 570 to prevent water from entering an interior of protective case 500.

In some embodiments, one or more sides of protective case 500 may include one or more finger ridges or hand grips to encourage a user to hold the protective case 500 in a certain way to prevent the user from covering or otherwise blocking rear antenna region opening 550, left antenna region opening 560, and/or right antenna region opening 570.

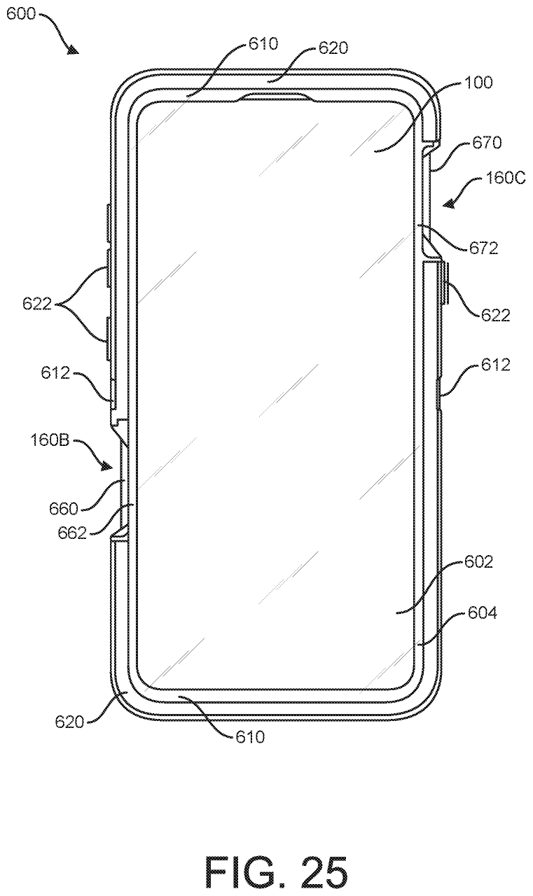

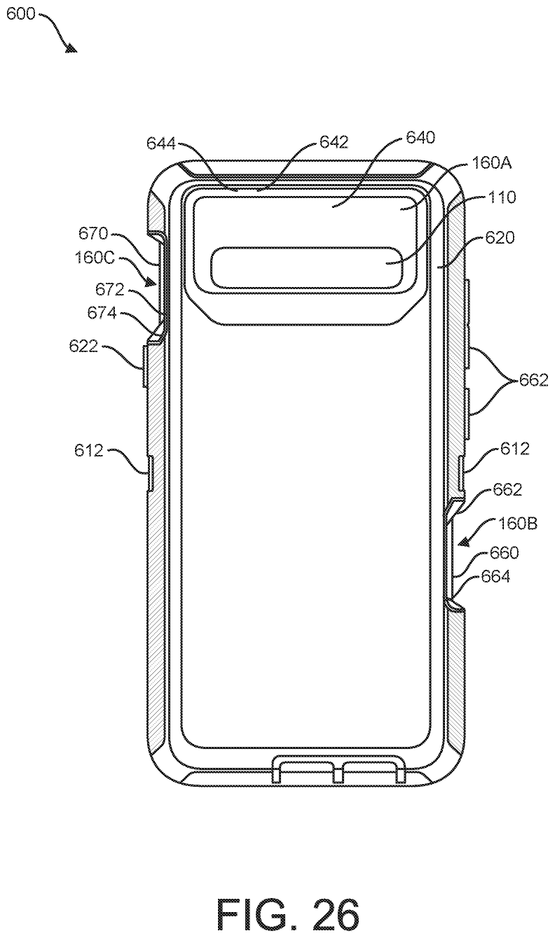

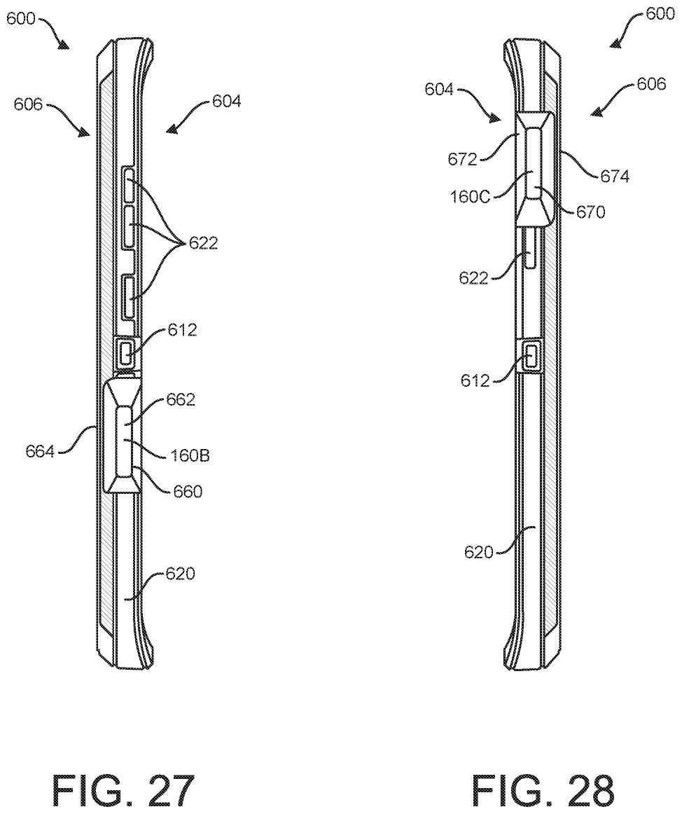

Referring next to FIGS. 25-28, a fifth embodiment of a protective case 600 for electronic device 100 is illustrated. FIG. 25 illustrates a front view of protective case 600 with inserted electronic device 100. FIG. 26 illustrates a rear view of protective case 600 with inserted electronic device 100. FIG. 27 illustrates a left side of protective case 600 with inserted electronic device 100. FIG. 28 illustrates a right side of protective case 600 with inserted electronic device 100.

Protective case 600 is illustratively a multi-layer protective case, including a rigid shell 610 that surrounds a portion of electronic device 100 and a cushion layer 620 removably disposable over the rigid shell 610.

Protective case 600 includes a first opening 602 providing access to display 102 of electronic device 100. In some embodiments, first opening 600 allows direct access to display 102 of electronic device 100. In other embodiments, first opening 602 includes a membrane or screen protector at least partially covering display 102, the membrane or screen protector permitting interactive touch through the membrane or screen protector to allow a user to interact with display 102 through the membrane or screen protector.

Protective case 600 includes a first side 604 including first opening 602 providing access to display 102 of installed electronic device 100 and a second side 606 configured to cover at least a portion of rear surface 112 of installed electronic device 100.

In some embodiments, the rigid shell 610 may include a first member partially covering a front surface 104 of electronic device 100 and a second member at least partially covering a rear surface 112 of electronic device 100, the first member and the second member releasably affixed to each other with one or more snaps. In some embodiments, the rigid shell 610 is formed from a rigid material, such as polycarbonate, ABS materials, propylene, thermal plastics, metals, composite materials, and other rigid materials used in injection molding. Rigid shell 610 may include one or more receivers 612 configured to releasably affix protective case 600 to a holster (see FIGS. 29-40).

In some embodiments, the cushion layer 620 fits snugly over the assembled rigid shell 610 to provide cushioning in a drop situation. In some embodiments, the cushion layer is formed from a thermoplastic material such as rubber or silicon, urethane, or other suitable material capable of stretching over the assembled rigid shell 610. In some embodiments, cushion layer 620 includes one or more raised pads 622 each providing access to one or more input buttons 120 of electronic device 100.

In some embodiments, protective case 600 includes an inner foam liner 630, similar to inner foam liner 530 or inner foam liner 530A of protective case 600 (see FIGS. 20-21). In some embodiments, inner foam liner 630 is affixed to an inner surface of rigid shell 610 to contact at least a portion of rear surface 112 of electronic device 100 when electronic device 100 is installed in protective case 600.

Protective case 600 further includes a single rear opening 640 providing direct access to camera region 110 and rear antenna region 160A of electronic device 100. A first aperture 642 in rigid shell 610 is aligned with a first aperture 644 in cushion layer 620 to provide single rear opening 640. In some embodiments, the first aperture 642 and first aperture 644 are further aligned with an aperture in inner foam liner 630 to provide single rear opening. In some embodiments, a rear surface of protective case 600 surrounding rear opening 640 is beveled or otherwise recessed to maintain one or more keep-out-zones of the one or more cameras in camera region 110 and/or antennas in rear antenna region 160A free from any obstructions.

Protective case 600 further includes a left antenna region opening 660 providing direct access to left antenna region 1606 of electronic device 100. In the embodiment illustrated in FIG. 27, four sides of left antenna region opening 660 are defined by a perimeter 662 of rigid shell 610.

Protective case 600 further includes a right antenna region opening 670 providing direct access to right antenna region 160C of electronic device 100. In the embodiment illustrated in FIG. 28, four sides of right antenna region opening 670 are defined by a perimeter 672 of rigid shell 610.

In some embodiments, left antenna region opening 660 is aligned with right antenna region opening 670. In other embodiments, as illustrated in FIGS. 24-28, left antenna region opening 660 is not aligned with right antenna region opening 670.

In the illustrated embodiment, left antenna region opening 560 is separated from first opening 502 only by perimeter 562 of rigid shell 510 and right antenna region opening 360 is separated from first opening 502 only by perimeter 572 of rigid shell 510 and perimeter 574 of cushion layer 520.

In some embodiments, single rear opening 640, left antenna region opening 660, and/or right antenna region opening 670 is covered with a membrane or other suitable material that is substantially transparent to radio waves having wavelengths used in 5G networks. In some embodiments, a perimeter of single rear opening 640, left antenna region opening 660, and/or right antenna region opening 670 includes a waterproof seal between the housing 150 of the installed electronic device 100 the perimeter of the respective opening 640, 660, 670, to prevent water from entering an interior of protective case 600.

In some embodiments, one or more sides of protective case 600 may include one or more finger ridges or hand grips to encourage a user to hold the protective case 600 in a certain way to prevent the user from covering or otherwise blocking single rear opening 640, left antenna region opening 660, and/or right antenna region opening 670.

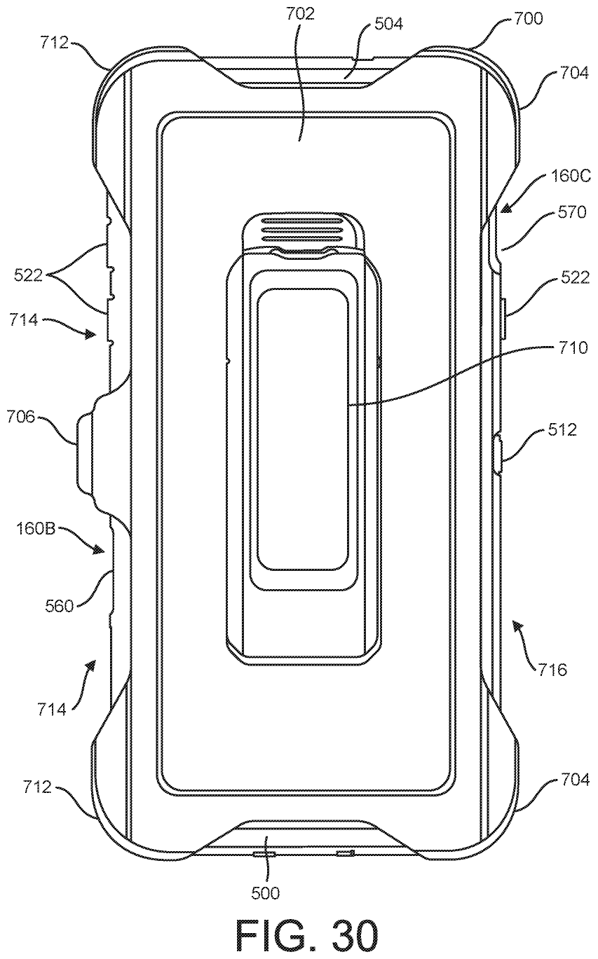

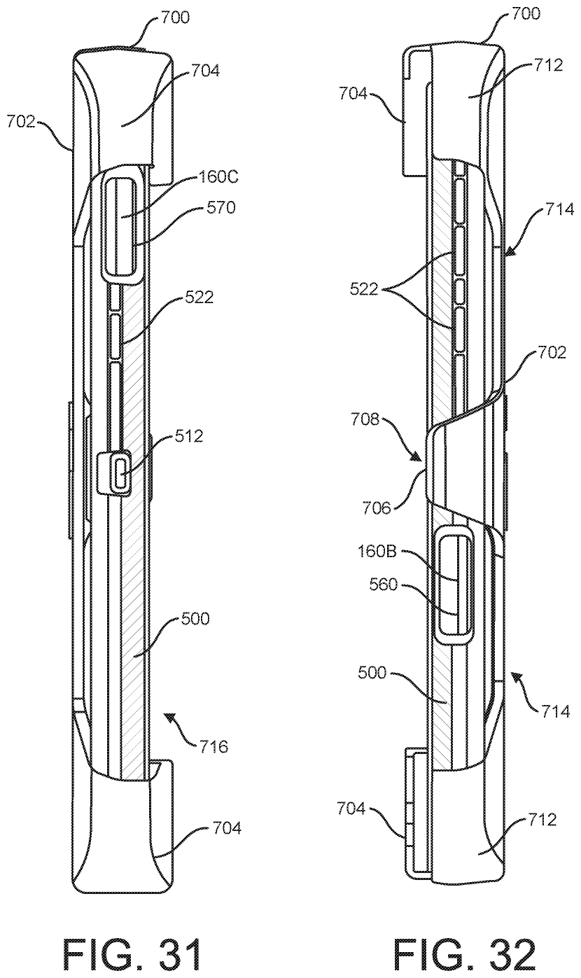

Referring next to FIGS. 29-32, a first embodiment of a holster 700 for a protective case 500 and electronic device 100 is illustrated. Exemplary holsters for protective cases are disclosed in U.S. Patent Application Publication 2015/026035, the disclosures of which are hereby incorporated by reference in their entirety. FIG. 29 illustrates a front view of holster 700 holding protective case 500 and electronic device 100. FIG. 30 illustrates a rear view of holster 700 holding protective case 500 and electronic device 100. FIG. 31 illustrates a left side view of holster 700 holding protective case 500 and electronic device 100. FIG. 32 illustrates a right side view of holster 700 holding protective case 500 and electronic device 100. Although holster 700 is illustrated in use with protective case 500, in other embodiments, holster 700 may be used with any suitable protective case, including protective cases 200, 300, 400, and 600.

In some embodiments, holster 700 includes a material that is opaque or substantially opaque to radio waves having wavelengths used in 5G networks, more particularly radio waves having frequencies above 3 GHz, and in some more particular cases from 30 GHz to 300 GHz. Holster 700 is configured to provide direct access to one or more of antenna regions 160A, 160B, and 160C.

Holster 700 includes a back 702 configured to cover at least a portion of electronic device 100 and protective case 500, and more particularly, at least a portion of display 102 of electronic device 100 and first opening 502 of protective case 500. Orienting case 500 in holster 700 such that display 102 and first opening 502 are positioned next to back 702 allows rear antenna region 160A to be positioned away from back 702 to better communicate with a 5G network.

Holster 700 includes one or more receivers 704 positioned along an edge of holster 700. Each receiver 704 is configured to engage a side of protective case 500. Opposite the side containing receivers 704 is flexible arm 706 and latch 708. An edge of protective case 500 is inserted into the one or more receivers 704 and then rotated until latch 708 engages a corresponding receiver 512 on protective case 500. To remove protective case 500 from holster 700, the flexible arm 706 is flexed away from receiver until latch 708 is free of receiver 512, and then protective case 500 is rotated away from latch 708 and withdrawn from receivers 704.

In some embodiments, holster 700 includes a belt clip 710 affixed to the rear of back 702. Holster 700 is illustrated without belt clip 710 in FIGS. 31 and 32. In some embodiments, belt clip 710 is rotatable with respect to back 702. In some embodiments, belt clip 710 can be locked in an open position to serve as a stand for horizontal viewing of display 102 of electronic device 100.

The corners 712 of holster 700 opposite receivers 704 are configured to allow the protective case 500 to rotate as it inserted and removed from holster 700.

One exemplary orientation of case 500 in holster 700 is illustrated in FIGS. 29-32. Another exemplary orientation of case 500 is to be rotated 180° from the orientation shown in FIG. 29 such that the left antenna region opening 560 is positioned between adjacent receivers 704 and the right antenna region opening 570 is positioned proximate flexible arm 708.

Holster 700 includes a first open area 714 between a corner 712 and flexible arm 706. First open area 714 is positioned to provide direct access to left side antenna area 1606 of electronic device 100 through left antenna region opening 560 or direct access to right side antenna area 160C of electronic device 100 through right antenna region opening 570 when electronic device 100 and protective case 500 are inserted in holster 700.

Holster 700 includes a second open area 716 between adjacent receivers 704. Second open area 716 is positioned to provide direct access to left side antenna area 160B of electronic device 100 through left antenna region opening 560 or direct access to right side antenna area 160C of electronic device 100 through right antenna region opening 570 when electronic device 100 and protective case 500 are inserted in holster 700.

In some embodiments, first open areas 714 and second open areas 716 are configured to allow a user to access and interact with raised pads 522 to control input buttons 120 on electronic device 100 when electronic device 100 is inserted in a protective case 500 affixed to holster 700.

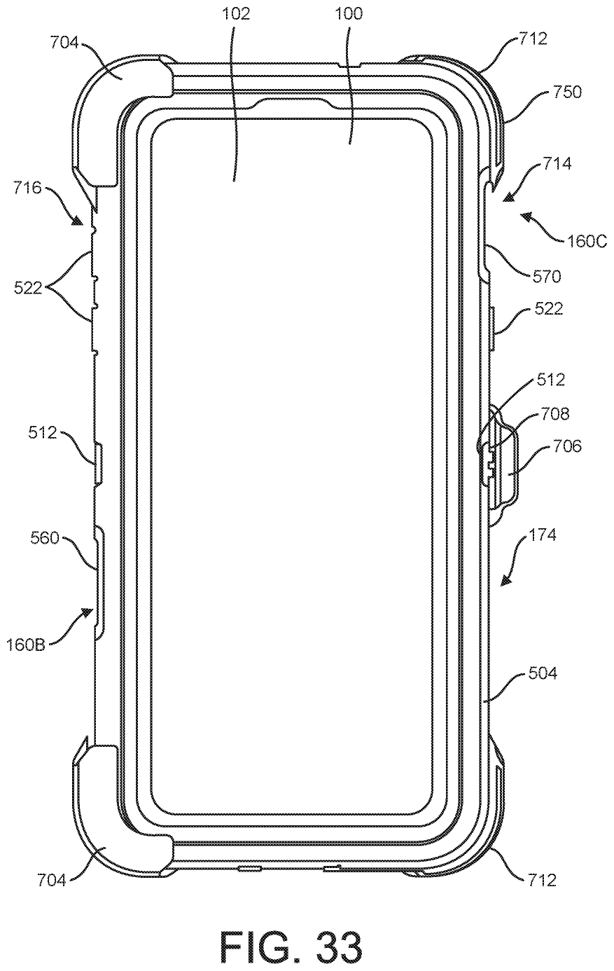

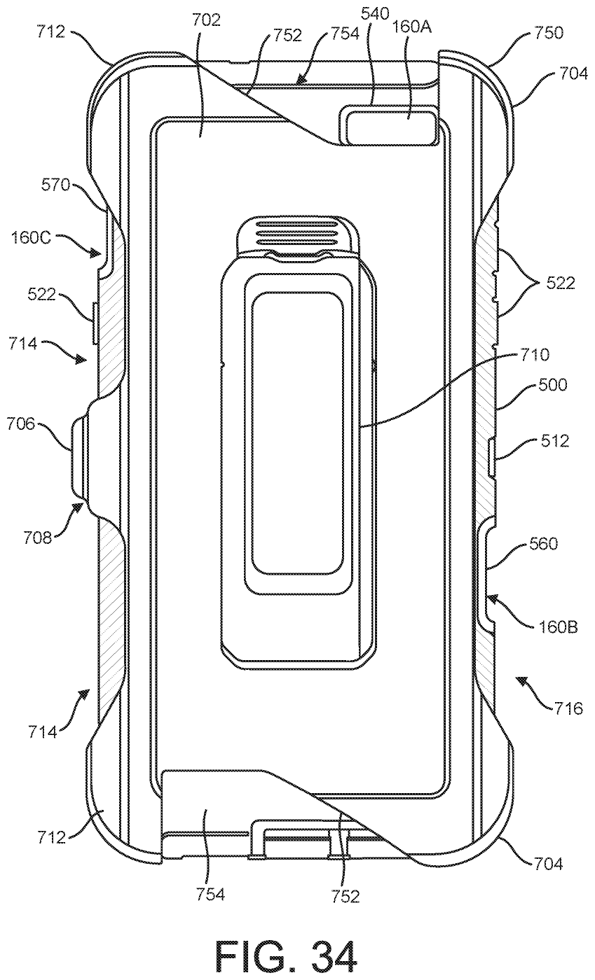

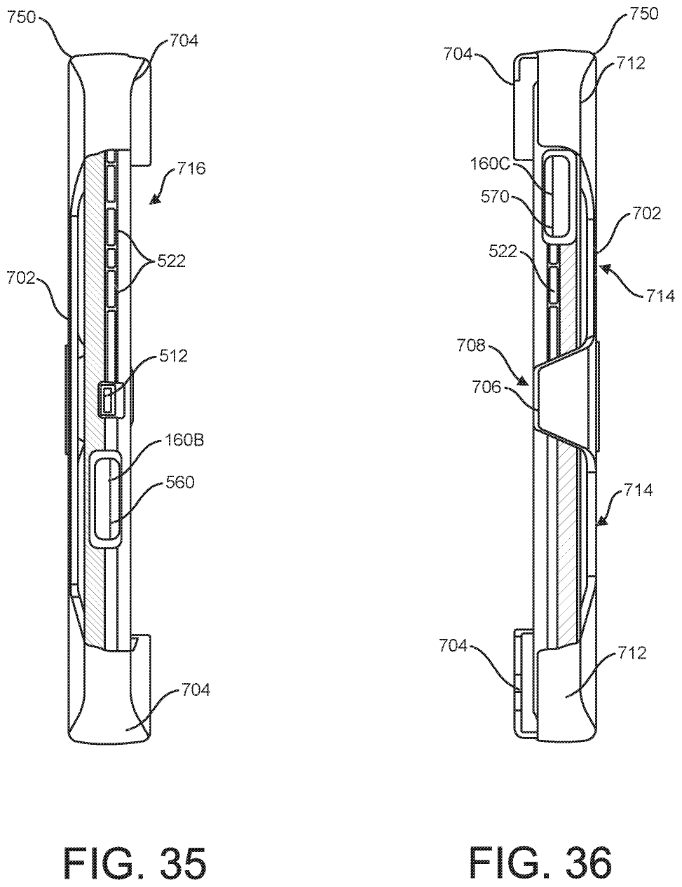

Referring next to FIGS. 33-36, a second embodiment of a holster 750 for a protective case 500 and electronic device 100 is illustrated. Holster 750 is similar to holster 700 (FIGS. 29-32) and similar part number are used to indicate similar features. FIG. 33 illustrates a front view of holster 750 holding protective case 500 and electronic device 100. FIG. 34 illustrates a rear view of holster 750 holding protective case 500 and electronic device 100. FIG. 35 illustrates a left side view of holster 750 holding protective case 500 and electronic device 100. FIG. 36 illustrates a right side view of holster 750 holding protective case 500 and electronic device 100. Although holster 750 is illustrated in use with protective case 500, in other embodiments, holster 700 may be used with any suitable protective case, including protective cases 200, 300, 400, and 600.

In some embodiments, holster 750 includes a material that is opaque or substantially opaque to radio waves having wavelengths used in 5G networks, more particularly radio waves having frequencies above 3 GHz, and in some more particular cases from 30 GHz to 300G Hz. Holster 700 is configured to provide direct access to one or more of antenna regions 160A, 160B, and 160C.

Holster 750 includes a back 702 configured to cover at least a portion of electronic device 100 and protective case 500, and more particularly, at least a portion of display 102 of electronic device 100 and first opening 502 of protective case 500.

Holster 750 includes one or more receivers 704 positioned along an edge of holster 750. Each receiver 704 is configured to engage a side of protective case 500. Opposite the side containing receivers 704 is flexible arm 706 and latch 708. An edge of protective case 500 is inserted into the one or more receivers 704 and then rotated until latch 708 engages a corresponding receiver 512 on protective case 500. To remove protective case 500 from holster 750, the flexible arm 706 is flexed away from receiver until latch 708 is free of receiver 512, and then protective case 500 is rotated away from latch 708 and withdrawn from receivers 704.

In some embodiments, holster 750 includes a belt clip 710 affixed to the rear of back 702. Holster 750 is illustrated without belt clip 710 in FIGS. 35 and 36.

The corners 712 of holster 750 opposite receivers 704 are configured to allow the protective case 500 to rotate as it inserted and removed from holster 750.

One exemplary orientation of case 500 in holster 750 is illustrated in FIGS. 33-36. Another exemplary orientation of case 500 is to be rotated 180° from the orientation shown in FIG. 33 such that the left antenna region opening 560 is positioned between adjacent receivers 704 and the right antenna region opening 570 is positioned proximate flexible arm 708.

Holster 750 includes a first open area 714 between a corner 712 and flexible arm 706. First open area 714 is positioned to provide direct access to left side antenna area 1606 of electronic device 100 through left antenna region opening 560 or direct access to right side antenna area 160C of electronic device 100 through right antenna region opening 570 when electronic device 100 and protective case 500 are inserted in holster 750.

Holster 750 includes a second open area 716 between adjacent receivers 704. Second open area 716 is positioned to provide direct access to left side antenna area 160B of electronic device 100 through left antenna region opening 560 or direct access to right side antenna area 160C of electronic device 100 through right antenna region opening 570 when electronic device 100 and protective case 500 are inserted in holster 750.

In some embodiments, first open areas 714 and second open areas 716 are configured to allow a user to access and interact with raised pads 522 to control input buttons 120 on electronic device 100 when electronic device 100 is inserted in a protective case 500 affixed to holster 750.

Back 702 of holster 750 illustratively includes one or more cutbacks 752 defining additional open areas 754 providing direct access to rear antenna region 160A through rear antenna region opening 550 of protective case 500. Back 702 of holster 750 illustratively includes two cutouts 752 each defining an open area 754 at opposite ends of back 702 to allow protective case 500 to be oriented as illustrated in FIGS. 33-36, or in an orientation in which case 500 is to be rotated 180° from the orientation shown in FIG. 34 such that the right antenna region opening 570 is positioned between adjacent receivers 704 and the right antenna region opening 560 is positioned proximate flexible arm 708.

Unlike holster 700, holster 750 is configured to allow protective case 500 to be oriented such that display 102 and first opening 502 are positioned next to back 702 of holster 750 or such that rear antenna region 160A and rear surface 506 of protective case 500 are positioned next to back 702 of holster 750 and still communicate with a 5G network. Thus, holster 750 provides four distinct orientations in which protective case 500 can be affixed.

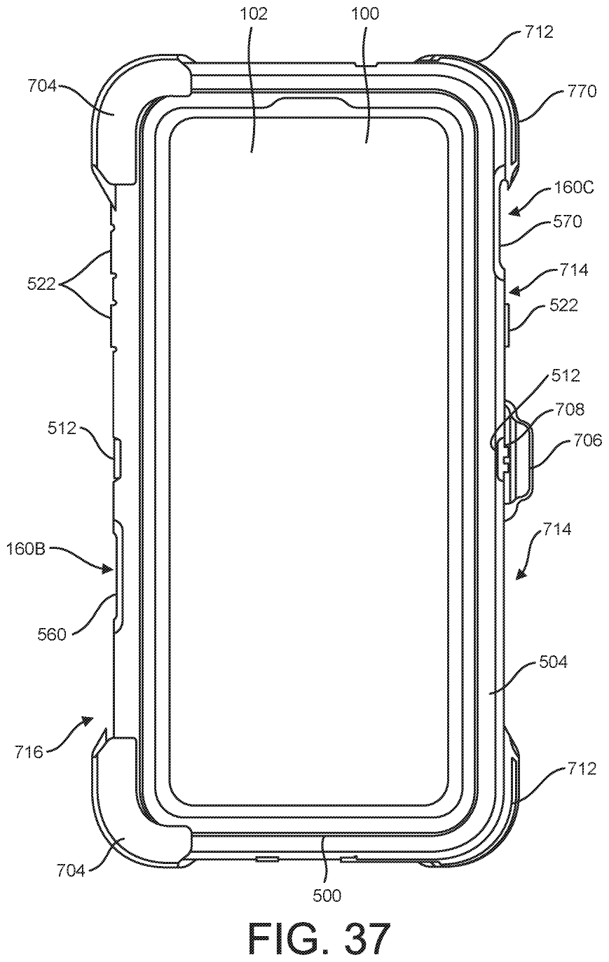

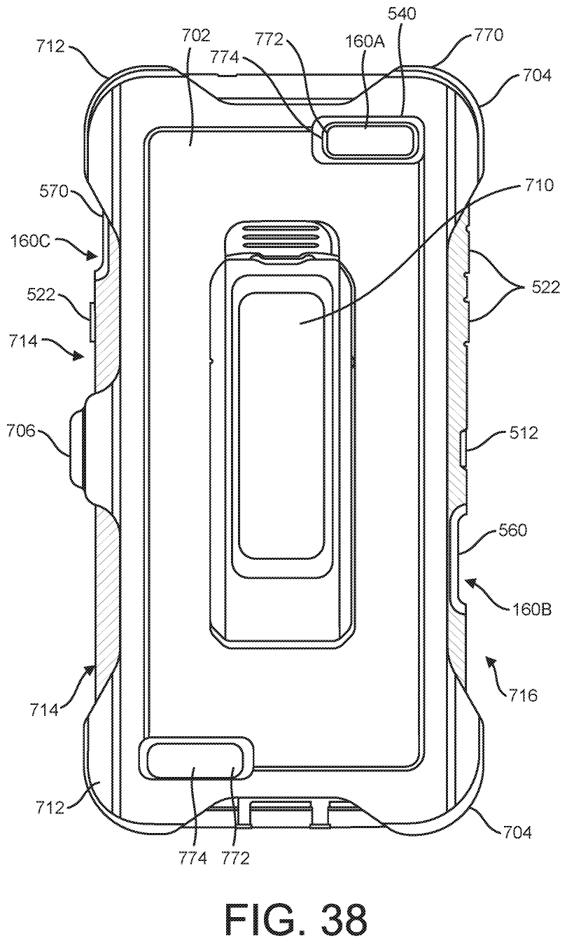

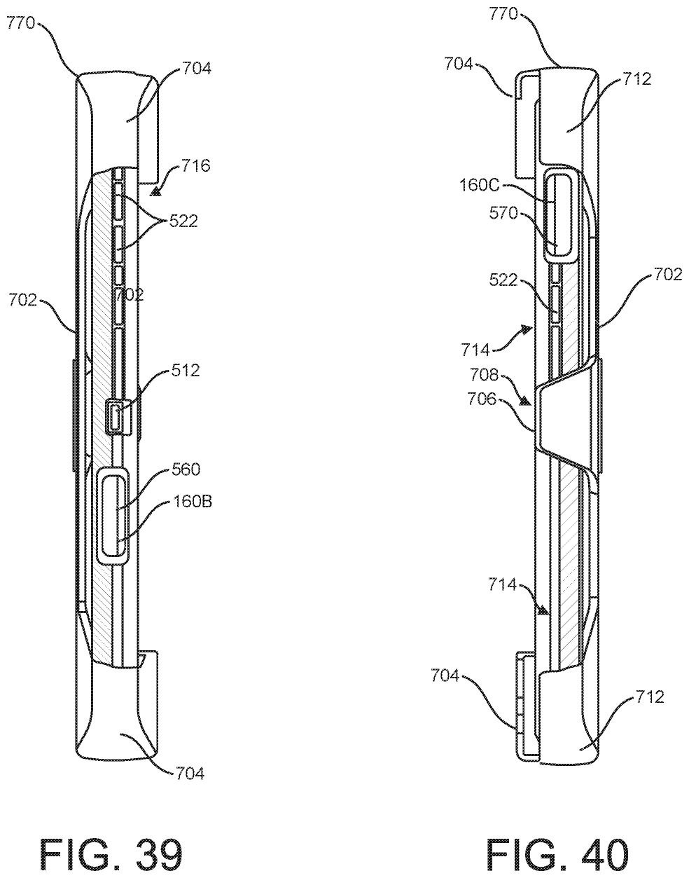

Referring next to FIGS. 37-40, a third embodiment of a holster 770 for a protective case 500 and electronic device 100 is illustrated. Holster 770 is similar to holster 700 (FIGS. 29-32) and holster 750 (FIGS. 33-36) and similar part number are used to indicate similar features. FIG. 37 illustrates a front view of holster 770 holding protective case 500 and electronic device 100. FIG. 38 illustrates a rear view of holster 770 holding protective case 500 and electronic device 100. FIG. 39 illustrates a left side view of holster 750 holding protective case 500 and electronic device 100. FIG. 40 illustrates a right side view of holster 770 holding protective case 500 and electronic device 100. Although holster 770 is illustrated in use with protective case 500, in other embodiments, holster 700 may be used with any suitable protective case, including protective cases 200, 300, 400, and 600.

In some embodiments, holster 770 includes a material that is opaque or substantially opaque to radio waves having wavelengths used in 5G networks, more particularly radio waves having frequencies above 3 GHz, and in some more particular cases from 30 GHz to 300 GHz. Holster 700 is configured to provide direct access to one or more of antenna regions 160A, 160B, and 160C.

Holster 770 includes a back 702 configured to cover at least a portion of electronic device 100 and protective case 500, and more particularly, at least a portion of display 102 of electronic device 100 and first opening 502 of protective case 500.

Holster 770 includes one or more receivers 704 positioned along an edge of holster 770. Each receiver 704 is configured to engage a side of protective case 500. Opposite the side containing receivers 704 is flexible arm 706 and latch 708. An edge of protective case 500 is inserted into the one or more receivers 704 and then rotated until latch 708 engages a corresponding receiver 512 on protective case 500. To remove protective case 500 from holster 770, the flexible arm 706 is flexed away from receiver until latch 708 is free of receiver 512, and then protective case 500 is rotated away from latch 708 and withdrawn from receivers 704.

In some embodiments, holster 770 includes a belt clip 710 affixed to the rear of back 702. Holster 770 is illustrated without belt clip 710 in FIGS. 39 and 40.

The corners 712 of holster 770 opposite receivers 704 are configured to allow the protective case 500 to rotate as it inserted and removed from holster 770.

One exemplary orientation of case 500 in holster 770 is illustrated in FIGS. 37-40. Another exemplary orientation of case 500 is to be rotated 180° from the orientation shown in FIG. 37 such that the left antenna region opening 560 is positioned between adjacent receivers 704 and the right antenna region opening 570 is positioned proximate flexible arm 708.

Holster 770 includes a first open area 714 between a corner 712 and flexible arm 706. First open area 714 is positioned to provide direct access to left side antenna area 160B of electronic device 100 through left antenna region opening 560 or direct access to right side antenna area 160C of electronic device 100 through right antenna region opening 570 when electronic device 100 and protective case 500 are inserted in holster 750.

Holster 770 includes a second open area 716 between adjacent receivers 704. Second open area 716 is positioned to provide direct access to left side antenna area 160B of electronic device 100 through left antenna region opening 560 or direct access to right side antenna area 160C of electronic device 100 through right antenna region opening 570 when electronic device 100 and protective case 500 are inserted in holster 750.

In some embodiments, first open areas 714 and second open areas 716 are configured to allow a user to access and interact with raised pads 522 to control input buttons 120 on electronic device 100 when electronic device 100 is inserted in a protective case 500 affixed to holster 770.

Back 702 of holster 750 illustratively includes one or more apertures 772 defining additional open areas 774 providing direct access to rear antenna region 160A through rear antenna region opening 550 of protective case 500. Back 702 of holster 772 illustratively includes two apertures 772 each defining an open area 774 at opposite ends of back 702 to allow protective case 500 to be oriented as illustrated in FIGS. 37-40, or in an orientation in which case 500 is to be rotated 180° from the orientation shown in FIG. 37 such that the right antenna region opening 570 is positioned between adjacent receivers 704 and the right antenna region opening 560 is positioned proximate flexible arm 708.

Unlike holster 700, holster 770 is configured to allow protective case 500 to be oriented such that display 102 and first opening 502 are positioned next to back 702 of holster 750 or such that rear antenna region 160A and rear surface 506 of protective case 500 are positioned next to back 702 of holster 770 and still communicate with a 5G network. Thus, holster 770 provides four distinct orientations in which protective case 500 can be affixed.

1. A protective case for an electronic device having a display, a first 5G antenna region on a rear surface of the electronic device, and a second 5G antenna region on a side surface of the electronic device, the protective case comprising: a first opening configured to provide access to the display of the electronic device when the electronic device is installed in the protective case; a first antenna region opening on a rear surface of the protective case, the first antenna region opening configured to be aligned with the first 5G antenna region and provide direct access to the first 5G antenna region when the electronic device is installed in the protective case; and a second antenna region opening on a side surface of the protective case, the second antenna region opening configured to be aligned with the second 5G antenna region and provide direct access to the second 5G antenna region when the electronic device is installed in the protective case.

2. The protective case of claim 1, wherein the protective case is a two-piece case comprising an inner cushion layer that surrounds a portion of the electronic device when the electronic device is installed in the protective case and a more rigid outer shell including one or more curved side walls configured to releasably engage the inner cushion layer.

3. The protective case of claim 2, wherein the inner cushion layer comprises a first material and the outer shell comprises a second material, the first material and the second material each being substantially opaque to radio waves having a frequency from 30 GHz to 300 GHz.

4. The protective case of claim 2, wherein the first antenna region opening comprises a first aperture through the inner cushion layer and a first aperture through the outer shell.

5. The protective case of claim 4, wherein the first antenna region opening is further configured to be aligned with a camera region of the electronic device and provide direct access to the camera region when the electronic device is installed in the protective case.

6. The protective case of claim 4, wherein the protective case further includes a camera region opening on the back surface of the protective case, the camera region opening being separate and distinct from the first antenna region opening and the second antenna region opening, the camera region opening comprising a second aperture through the inner cushion layer and a second aperture through the outer shell.

7. The protective case of claim 2, wherein the first opening and the first antenna region opening are separated by a boundary comprising the inner cushion layer.

8. The protective case of claim 7, wherein the boundary further comprises the outer shell.

9. The protective case of claim 2, wherein the first opening and the first antenna region opening comprise a single aperture defined by a single perimeter.

10. The protective case of claim 2, further comprising a third antenna region opening on a side surface of the protective case, the third antenna region opening configured to be aligned with and provide direct access to a third 5G antenna region on a side surface of the electronic device when the electronic device is installed in the protective case.

11. The protective case of claim 10, wherein the first opening, the first antenna region opening, and the second antenna region opening comprise a single aperture defined by a single perimeter.

12. The protective case of claim 1, wherein the protective case is a one-piece case comprising a cushioning member that surrounds a portion of the electronic device when the electronic device is installed in the protective case and a more rigid structural member permanently affixed to the cushioning member.

13. The protective case of claim 12, wherein the cushioning member comprises a first material and the structural member comprises a second material, the first material and the second material each being substantially opaque to radio waves having a frequency from 30 GHz to 300 GHz.

14. The protective case of claim 12, wherein the first antenna region opening comprises a first aperture through the cushioning member and a first aperture through the structural member.

15. The protective case of claim 14, wherein the first antenna region opening is further configured to be aligned with a camera region of the electronic device and provide direct access to the camera region when the electronic device is installed in the protective case.

16. The protective case of claim 14, wherein the protective case further includes a camera region opening on the back surface of the protective case, the camera region opening being separate and distinct from the first antenna region opening and the second antenna region opening, the camera region opening comprising a second aperture through the cushioning member and a second aperture through the structural member.

17. The protective case of claim 12, wherein the first opening and the first antenna region opening are separated by a boundary comprising the cushioning member.

18. The protective case of claim 17, wherein the boundary further comprises the structural member.

19. The protective case of claim 12, wherein the first opening and the first antenna region opening comprise a single aperture defined by a single perimeter.

20. The protective case of claim 12, further comprising a third antenna region opening on a side surface of the protective case, the third antenna region opening configured to be aligned with and provide direct access to a third 5G antenna region on a side surface of the electronic device when the electronic device is installed in the protective case.

21. The protective case of claim 20, wherein the first opening, the first antenna region opening, and the second antenna region opening comprise a single aperture defined by a single perimeter.

22. The protective case of claim 12, wherein at least a portion of the cushioning member and a portion of the structural member comprises a transparent material.

23. The protective case of claim 1, wherein the protective case is a multi-layer case comprising a rigid shell that surrounds a portion of the electronic device when the electronic device is installed in the protective case and a cushion layer removably disposable over the rigid shell.

24. The protective case of claim 23, wherein the rigid shell comprises a first material and the cushion layer comprises a second material, the first material and the second material each being substantially opaque to radio waves having a frequency from 30 GHz to 300 GHz.

25. The protective case of claim 23, wherein the first antenna region opening comprises a first aperture through the rigid shell and a first aperture through the cushion layer.

26. The protective case of claim 25, wherein the first antenna region opening is further configured to be aligned with a camera region of the electronic device and provide direct access to the camera region when the electronic device is installed in the protective case.

27. The protective case of claim 25, wherein the protective case further includes a camera region opening on the rear surface of the protective case, the camera region opening being separate and distinct from the first antenna region opening and the second antenna region opening, the camera region opening comprising a second aperture through the rigid shell and a second aperture through the cushion layer.

28. The protective case of claim 23, further comprising an inner foam liner affixed to the rigid shell and configured to contact at least a portion of a rear surface of the electronic device when the electronic device is installed in the protective case.

29. The protective case of claim 28, wherein the first antenna region opening comprises a first aperture through the rigid shell, a first aperture through the cushion layer, and a first aperture through the inner foam liner.

30. The protective case of claim 23, wherein the first opening and the first antenna region opening are separated by a boundary comprising the rigid shell.

31. The protective case of claim 30, wherein the boundary further comprises the cushion layer.

32. The protective case of claim 23, wherein the first opening and the first antenna region opening comprise a single aperture defined by a single perimeter.

33. The protective case of claim 23, further comprising a third antenna region opening on a side surface of the protective case, the third antenna region opening configured to be aligned with and provide direct access to a third 5G antenna region on a side surface of the electronic device when the electronic device is installed in the protective case.

34. The protective case of claim 33, wherein the first opening, the first antenna region opening, and the second antenna region opening comprise a single aperture defined by a single perimeter.

35. The protective case of claim 2, further comprising a holster.

36. The protective case of claim 35, wherein the holster includes a back, at least two receivers positioned along a first edge of the back and configured to releasably engage a side of protective case, and a flexible arm positioned along a second edge of the back opposite the first edge, the flexible arm including a latch configured to engage a receiver on the protective case to secure the protective case to the holster.

37. The protective case of claim 36, wherein the holster comprises a first open area positioned between the two receivers, the first open area configured to provide direct access to the second antenna region on the side surface of the electronic device through the second antenna region opening of the protective case when the electronic device is installed in the protective case and the protective case is secured in the holster.

38. The protective case of claim 36, wherein the holster comprises a second open area positioned between the flexible arm and a corner of the holster, the second open area configured to provide direct access to the second antenna region on the side surface of the electronic device through the second antenna region opening of the protective case when the electronic device is installed in the protective case and the protective case is secured in the holster.

39. The protective case of claim 36, wherein the holster comprises a third open area positioned on the back of the holster, the third open area configured to provide direct access to the first antenna region of the electronic device on the rear surface of the electronic device through the first antenna region opening of the protective case when the electronic device is installed in the protective case and the protective case is secured in the holster.

40. The protective case of claim 39, wherein the third open area is an aperture formed in the back of the holster.

41. A holster for an electronic device having a first 5G antenna region on a rear surface of the electronic device and a second 5G antenna region on a side surface of the electronic device, the holster comprising: a back including a first open area configured to provide direct access to the first antenna region of the electronic device when the electronic device is secured to the holster; at least two receivers positioned along a first edge of the back and configured to releasably engage a side of electronic device; and a flexible arm positioned along a second edge of the back opposite the first edge, the flexible arm including a latch configured to engage a receiver on the electronic device to secure the electronic device to the holster.

42. The holster of claim 41, further comprising a second open area positioned between the two receivers, the second open area configured to provide direct access to the second antenna region on the side surface of the electronic device when the electronic device is secured in the holster.

43. The holster of claim 41, further comprising a third open area positioned between the flexible arm and a corner of the holster, the third open area configured to provide direct access to the second antenna region on the side surface of the electronic device when the electronic device is secured in the holster.

44. The holster of claim 41, wherein the first open area is an aperture formed in the back of the holster.

45. The holster of claim 41, further comprising a second open area positioned between the two receivers and a third open area positioned between the flexible arm and a corner of the holster, wherein the second open area is configured to provide direct access to the second antenna region on the side surface of the electronic device when the electronic device is secured in the holster in a first configuration; and wherein the third open area configured to provide direct access to the second antenna region on the side surface of the electronic device when the electronic device is secured in the holster in a second configuration.

46. The holster of claim 42, wherein the third open area is configured to provide direct access to a third antenna region positioned on a second side surface of the electronic device when the electronic device is secured in the holster in the first configuration and the second open area is configured to provide direct access to the third antenna region when the electronic device is secured in the holster in the second configuration.

The elements, components, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in other situations,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure has been presented for purposes of illustration and description. Other modifications and variations may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention except as limited by the prior art.

What is claimed is:

1. A protective case for an electronic device having a display, a first 5G antenna region on a rear surface of the electronic device, and a second 5G antenna region on a side surface of the electronic device, the protective case comprising:
a first opening configured to provide access to the display of the electronic device when the electronic device is installed in the protective case;
a first antenna region opening on a rear surface of the protective case, the first antenna region opening configured to be aligned with the first 5G antenna region and provide direct access to the first 5G antenna region when the electronic device is installed in the protective case; and
a second antenna region opening on a side surface of the protective case, the second antenna region opening configured to be aligned with the second 5G antenna region and provide direct access to the second 5G antenna region when the electronic device is installed in the protective case.

2. The protective case of claim 1, wherein the protective case is a two-piece case comprising an inner cushion layer that surrounds a portion of the electronic device when the electronic device is installed in the protective case and a more rigid outer shell including one or more curved side walls configured to releasably engage the inner cushion layer.

3. The protective case of claim 2, wherein the inner cushion layer comprises a first material and the outer shell comprises a second material, the first material and the second material each being substantially opaque to radio waves having a frequency from 30 GHz to 300 GHz.

4. The protective case of claim 2, wherein the first antenna region opening comprises a first aperture through the inner cushion layer and a first aperture through the outer shell.

5. The protective case of claim 4, wherein the first antenna region opening is further configured to be aligned with a camera region of the electronic device and provide direct access to the camera region when the electronic device is installed in the protective case.

6. The protective case of claim 4, wherein the protective case further includes a camera region opening on the back surface of the protective case, the camera region opening being separate and distinct from the first antenna region opening and the second antenna region opening, the camera region opening comprising a second aperture through the inner cushion layer and a second aperture through the outer shell.

7. The protective case of claim 2, wherein the first opening and the first antenna region opening are separated by a boundary comprising the inner cushion layer, wherein the boundary further comprises the outer shell.

8. The protective case of claim 1, wherein the first opening and the first antenna region opening comprise a single aperture defined by a single perimeter.

9. The protective case of claim 1, further comprising a third antenna region opening on a side surface of the protective case, the third antenna region opening configured to be aligned with and provide direct access to a third 5G antenna region on a side surface of the electronic device when the electronic device is installed in the protective case.

10. The protective case of claim 9, wherein the first opening, the first antenna region opening, and the second antenna region opening comprise a single aperture defined by a single perimeter.

11. The protective case of claim 1, wherein the protective case is a one-piece case comprising a cushioning member that surrounds a portion of the electronic device when the electronic device is installed in the protective case and a more rigid structural member permanently affixed to the cushioning member.

12. The protective case of claim 11, wherein the cushioning member comprises a first material and the structural member comprises a second material, the first material and the second material each being substantially opaque to radio waves having a frequency from 30 GHz to 300 GHz.

13. The protective case of claim 11, wherein the first antenna region opening comprises a first aperture through the cushioning member and a first aperture through the structural member.

14. The protective case of claim 13, wherein the first antenna region opening is further configured to be aligned with a camera region of the electronic device and provide direct access to the camera region when the electronic device is installed in the protective case.

15. The protective case of claim 14, wherein the protective case further includes a camera region opening on the back surface of the protective case, the camera region opening being separate and distinct from the first antenna region opening and the second antenna region opening, the camera region opening comprising a second aperture through the cushioning member and a second aperture through the structural member.

16. The protective case of claim 11, further comprising a third antenna region opening on a side surface of the protective case, the third antenna region opening configured to be aligned with and provide direct access to a third 5G antenna region on a side surface of the electronic device when the electronic device is installed in the protective case.

17. The protective case of claim 16, wherein the first opening, the first antenna region opening, and the second antenna region opening comprise a single aperture defined by a single perimeter.

18. The protective case of claim 1, wherein the protective case is a multi-layer case comprising a rigid shell that surrounds a portion of the electronic device when the electronic device is installed in the protective case and a cushion layer removably disposable over the rigid shell, wherein the rigid shell comprises a first material and the cushion layer comprises a second material, the first material and the second material each being substantially opaque to radio waves having a frequency from 30 GHz to 300 GHz.

19. The protective case of claim 18, wherein the first antenna region opening comprises a first aperture through the rigid shell and a first aperture through the cushion layer.

20. The protective case of claim 19, further comprising an inner foam liner affixed to the rigid shell and configured to contact at least a portion of a rear surface of the electronic device when the electronic device is installed in the protective case.

21. The protective case of claim 18, further comprising a third antenna region opening on a side surface of the protective case, the third antenna region opening configured to be aligned with and provide direct access to a third 5G antenna region on a side surface of the electronic device when the electronic device is installed in the protective case.

22. The protective case of claim 2 further comprising a holster, wherein the holster includes a back, at least two receivers positioned along a first edge of the back and configured to releasably engage a side of protective case, and a flexible arm positioned along a second edge of the back opposite the first edge, the flexible arm including a latch configured to engage a receiver on the protective case to secure the protective case to the holster.

23. The protective case of claim 22, wherein the holster comprises a first open area positioned between the two receivers, the first open area configured to provide direct access to the second antenna region on the side surface of the electronic device through the second antenna region opening of the protective case when the electronic device is installed in the protective case and the protective case is secured in the holster.

24. The protective case of claim 23, wherein the holster comprises a second open area positioned between the flexible arm and a corner of the holster, the second open area configured to provide direct access to the second antenna region on the side surface of the electronic device through the second antenna region opening of the protective case when the electronic device is installed in the protective case and the protective case is secured in the holster.

25. The protective case of claim 24, wherein the holster comprises a third open area positioned on the back of the holster, the third open area configured to provide direct access to the first antenna region of the electronic device on the rear surface of the electronic device through the first antenna region opening of the protective case when the electronic device is installed in the protective case and the protective case is secured in the holster.

26. A holster for an electronic device having a first 5G antenna region on a rear surface of the electronic device and a second 5G antenna region on a side surface of the electronic device, the holster comprising:
a back including a first open area configured to provide direct access to the first antenna region of the electronic device when the electronic device is secured to the holster;
at least two receivers positioned along a first edge of the back and configured to releasably engage a side of electronic device; and
a flexible arm positioned along a second edge of the back opposite the first edge, the flexible arm including a latch configured to engage a receiver on the electronic device to secure the electronic device to the holster.

27. The holster of claim 26, further comprising a second open area positioned between the two receivers and a third open area positioned between the flexible arm and a corner of the holster,
wherein the second open area is configured to provide direct access to the second antenna region on the side surface of the electronic device when the electronic device is secured in the holster in a first configuration; and
wherein the third open area configured to provide direct access to the second antenna region on the side surface of the electronic device when the electronic device is secured in the holster in a second configuration.
